(19) United States
(12) Patent Application Publication
(10) Pub. No.: US 2025/0341417 A1
(43) Pub. Date: Nov. 6, 2025

(54) ELECTRONIC DEVICE COMPRISING SENSOR, AND OPERATING METHOD THEREFOR

(71) Applicant: Samsung Electronics Co., Ltd., Suwon-si (KR)

(72) Inventors: Heewoong YOON, Suwon-si (KR); Jongah KIM, Suwon-si (KR); Kihyuk LEE, Suwon-si (KR); Donghan LEE, Suwon-si (KR); Gwangho CHOI, Suwon-si (KR)

(21) Appl. No.: 19/264,425

(22) Filed: Jul. 9, 2025

Related U.S. Application Data
(63) Continuation of application No. PCT/KR2023/020769, filed on Dec. 15, 2023.

(30) Foreign Application Priority Data
Jan. 10, 2023 (KR) 10-2023-0003359
May 2, 2023 (KR) 10-2023-0056900

(51) Int. Cl. G01J 1/44

(52) U.S. Cl. CPC G01J 1/44

(57) ABSTRACT

An electronic device is provided. The electronic device includes a display, a sensor, disposed on a lower end portion of the display, including a plurality of light-receiving elements, a plurality of analog-to-digital converters (ADCs), and a plurality of switches, memory, comprising one or more storage media, storing instructions, and one or more processors, wherein instructions, when executed by the one or more processors, cause the electronic device to control the plurality of switches to connect the first light-receiving element, the second light-receiving element and the third light-receiving element in series to the first ADC in a first mode in which the plurality of light-receiving elements are activated at designated time intervals during a first time period, and control the plurality of switches to connect the first light-receiving element is connected to the first ADC, the second light-receiving element to the second ADC and the third light-receiving element to the third ADC in a second mode in which the plurality of light-receiving elements remain active during a second time period.

### CROSS-REFERENCE TO RELATED APPLICATION(S)

This application is a continuation application, claiming priority under 35 U.S.C. § 365 (c), of an International application No. PCT/KR2023/020769, filed on Dec. 15, 2023, which is based on and claims the benefit of a Korean patent application number 10-2023-0003359, filed on Jan. 10, 2023, in the Korean Intellectual Property Office, and of a Korean patent application number 10-2023-0056900, filed on May 2, 2023, in the Korean Intellectual Property Office, the disclosure of each of which is incorporated by reference herein in its entirety.

### BACKGROUND

### 1. Field

The disclosure relates to an electronic device including a sensor and a method for operating the same.

### 2. Description of Related Art

Advancing information communication technologies and semiconductor technologies accelerate the spread and use of various electronic devices. In particular, recent electronic devices may perform communication while being carried and may include one or more sensors for obtaining various types of ambient information. An electronic device may obtain various pieces of information using sensors.

Among the sensors of the electronic device, a camera sensor, an ultra violet (UV) sensor, an iris sensor, a spectroscopic sensor, an infrared (IR) (proximity/gesture) sensor, a red, green, and blue (RGB) sensor, an illuminance sensor (or an ambient light sensor or an ALS sensor), and/or a flicker sensor uses light.

In particular, the electronic device may measure the illuminance value of the electronic device using an illuminance sensor and adjust the color of the screen displayed on the display.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a sensor and a method for operating the same.

Additional aspects will be set forth in part in the description which follows and, in part, will be apparent from the description, or may be learned by practice of the presented embodiments.

In accordance with an aspect of the disclosure, an electronic device is provided. The electronic device includes a display, a sensor, disposed on a lower end portion of the display, including a plurality of light receiving elements, a plurality of analog-to-digital converters (ADCs), and a plurality of switches, wherein the plurality of light-receiving elements include a first light receiving element, a second light receiving element, and a third light receiving element configured to detect light of different wavelengths, and wherein the plurality of ADCs include a first ADC corresponding to the first light receiving element, a second ADC corresponding to the second light receiving element, and a third ADC corresponding to the third light receiving element, memory, including one or more storage media, storing instructions, and one or more processors communicatively coupled to the display, the sensor, and the memory, wherein the instructions, when executed by the one or more processors individually or collectively, cause the electronic device to control the plurality of switches to connect the first light receiving element, the second light receiving element, and the third light receiving element in series to the first ADC in a first mode in which the plurality of light receiving elements are activated every designated time during a first time period, and control the plurality of switches to connect the first light receiving element to the first ADC, connect the second light receiving element to the second ADC, and connect the third light receiving element to the third ADC in a second mode in which the plurality of light receiving elements remain active during a second time period.

In accordance with another aspect of the disclosure, a method for operating an electronic device is provided. The method includes controlling a plurality of switches to connect a first light receiving element, second light receiving element, and a third light receiving element in series to a first ADC in a first mode in which the light receiving elements are activated every designated time during a first time period, and controlling the plurality of switches to connect the first light receiving element to the first ADC, connect the second light receiving element to a second ADC, and connect the third light receiving element to a third ADC in a second mode in which the plurality of light receiving elements remain active during a second time period.

In accordance with another aspect of the disclosure, one or more non-transitory computer-readably storage medium including computer-executable instructions that, when executed by one or more processors of an electronic device individually or collectively, cause the electronic device to perform operations are provided. The operations include controlling a plurality of switches to connect a first light receiving element, a second light receiving element, and a third light receiving element in series to a first ADC in a first mode in which the light receiving elements are activated every designated time during a first time period, and controlling the plurality of switches to connect the first light receiving element to the first ADC, connect the second light receiving element to a second ADC, and connect the third light receiving element to a third ADC in a second mode in which the plurality of light receiving elements remain active during a second time period.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2 is a block diagram illustrating a display device according to an embodiment of the disclosure;

FIG. 3A is a block diagram schematically illustrating an electronic device according to an embodiment of the disclosure;

FIG. 3B is a graph illustrating a first mode and a second mode of an electronic device according to an embodiment of the disclosure;

FIG. 4A is a circuit diagram illustrating a first sensor array according to an embodiment of the disclosure;

FIG. 4B is a circuit diagram illustrating a first sensor array when an electronic device is in a first mode according to an embodiment of the disclosure;

FIG. 4C is a circuit diagram illustrating a first sensor array when an electronic device is in a second mode according to an embodiment of the disclosure;

FIG. 5 is a flowchart illustrating an operation of obtaining a value related to a color temperature and an illuminance value by an electronic device according to an embodiment of the disclosure;

FIG. 6 is a flowchart illustrating an operation of obtaining a first illuminance value when an electronic device is in a first mode according to an embodiment of the disclosure;

FIG. 7 is a flowchart illustrating an operation of obtaining a second illuminance value when an electronic device is in a second mode according to an embodiment of the disclosure;

FIG. 8 is a flowchart illustrating an operation of obtaining a value related to a color temperature by an electronic device according to an embodiment of the disclosure;

FIG. 9A is a circuit diagram illustrating a second sensor array when an electronic device is in a first mode according to an embodiment of the disclosure;

FIG. 9B is a circuit diagram illustrating a second sensor array when an electronic device is in a second mode according to an embodiment of the disclosure;

FIG. 10 is a flowchart illustrating an operation of obtaining a value related to a color temperature and an illuminance value by an electronic device according to an embodiment of the disclosure; and

FIGS. 11A and 11B are views illustrating a plurality of light receiving elements included in a sensor array according to a comparative embodiment and a plurality of light receiving elements included in a second sensor array according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

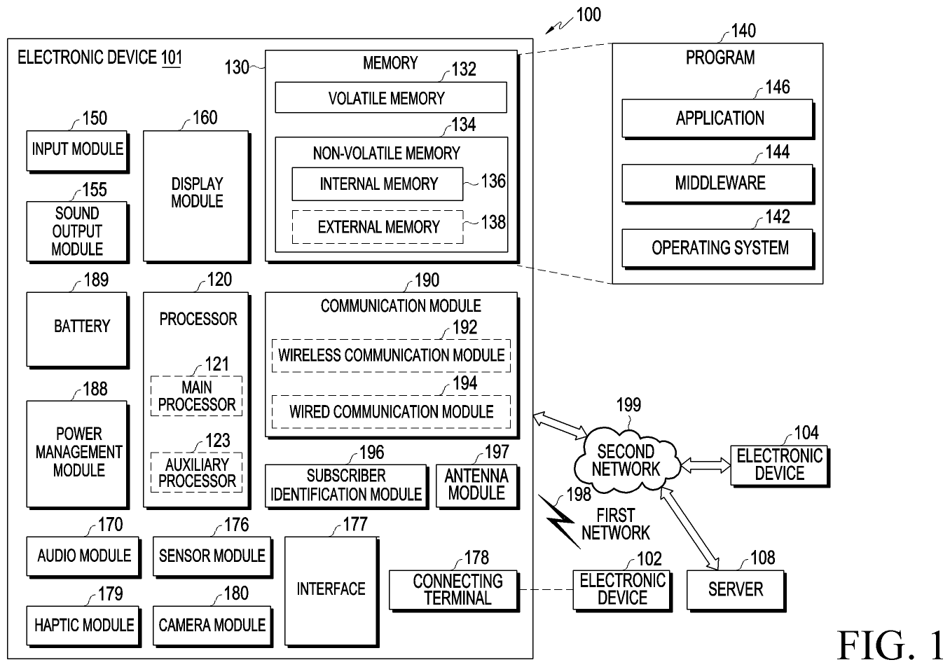

FIG. 1 is a block diagram illustrating an electronic device 101 in a network environment 100 according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™ wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

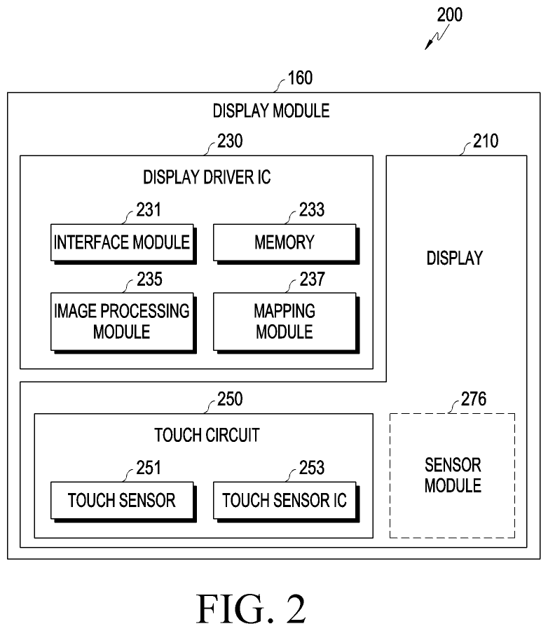

FIG. 2 is a block diagram 200 illustrating a display module 160 according to an embodiment of the disclosure.

Referring to FIG. 2, the display module 160 may include a display 210 and a display driver integrated circuit (DDI) 230 to control the display 110. The DDI 230 may include an interface module 231, memory 233 (e.g., buffer memory), an image processing module 235, or a mapping module 237. The DDI 230 may receive image information that contains image data or an image control signal corresponding to a command to control the image data from another component of the electronic device 101 via the interface module 231. For example, according to an embodiment, the image information may be received from the processor 120 (e.g., the main processor 121 (e.g., an application processor) of FIG. 1) or the auxiliary processor 123 of FIG. 1 (e.g., a graphics processing unit) operated independently from the function of the main processor 121. The DDI 230 may communicate, for example, with touch circuitry 250 or the sensor module 276 (e.g., the sensor module 176 of FIG. 1) via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 210. The mapping module 237 may generate a voltage value or a current value corresponding to the image data pre-processed or post-processed by the image processing module 235. According to an embodiment, the generating of the voltage value or current value may be performed, for example, based at least in part on one or more attributes of the pixels (e.g., an array, such as an RGB stripe or a pentile structure, of the pixels, or the size of each subpixel) of the display 210. At least some pixels of the display 210 may be driven, for example, based at least in part on the voltage value or the current value such that visual information (e.g., a text, an image, or an icon) corresponding to the image data may be displayed via the display 210.

According to an embodiment, the display module 160 may further include the touch circuitry 250. The touch circuitry 250 may include a touch sensor 251 and a touch sensor IC 253 to control the touch sensor 151. The touch sensor IC 253 may control the touch sensor 251 to sense a touch input or a hovering input with respect to a certain position on the display 210. To achieve this, for example, the touch sensor IC 253 may detect (e.g., measure) a change in a signal (e.g., a voltage, a quantity of light, a resistance, or a quantity of one or more electric charges) corresponding to the certain position on the display 210. The touch sensor IC 253 may provide input information (e.g., a position, an area, a pressure, or a time) indicative of the touch input or the hovering input detected to the processor (e.g., the processor 120 of FIG. 1). According to an embodiment, at least part (e.g., the touch sensor IC 253) of the touch circuitry 250 may be formed as part of the display 210 or the DDI 230, or as part of another component (e.g., the auxiliary processor 123 of FIG. 1) disposed outside the display module 160.

According to an embodiment, the display module 160 may further include at least one sensor (e.g., a fingerprint sensor, an iris sensor, a pressure sensor, or an illuminance sensor) of the sensor module 276 or a control circuit for the at least one sensor. In such a case, the at least one sensor or the control circuit for the at least one sensor may be embedded in one portion of a component (e.g., the display 210, the DDI 230, or the touch circuitry 250)) of the display module 160. For example, when the sensor module 276 embedded in the display module 160 includes a biometric sensor (e.g., a fingerprint sensor), the biometric sensor may obtain biometric information (e.g., a fingerprint image) corresponding to a touch input received via a portion of the display 210. As another example, when the sensor module 276 embedded in the display module 160 includes a pressure sensor, the pressure sensor may obtain pressure information corresponding to a touch input received via a partial or whole area of the display 210. According to an embodiment, the touch sensor 251 or the sensor module 276 may be disposed between pixels in a pixel layer of the display 210, or over or under the pixel layer.

Although FIG. 2 illustrates that the sensor module 276 is included in the display module 160, the sensor module 276 may be implemented as a component independent from the display module 160 rather than being included in the display module 160.

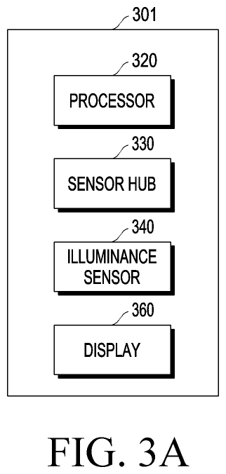

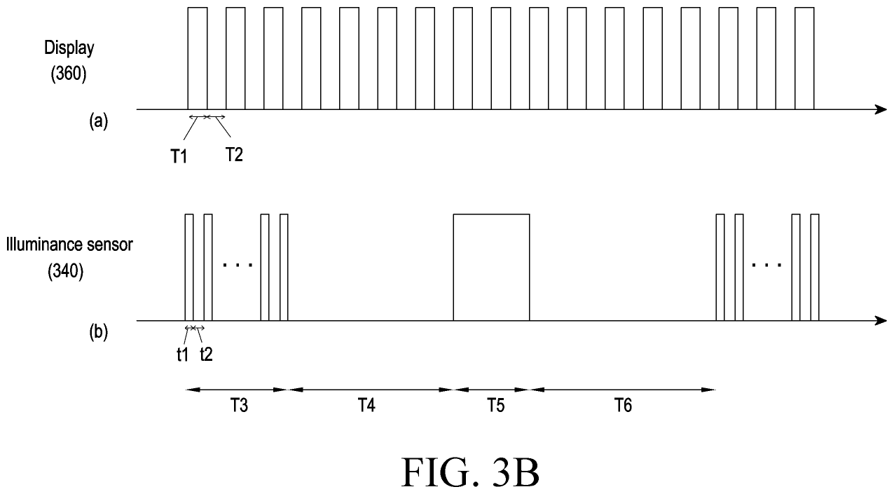

FIG. 3A is a block diagram schematically illustrating an electronic device according to an embodiment of the disclosure.

Referring to FIG. 3A, according to an embodiment, an electronic device 301 may include a processor 320, a sensor hub 330, an illuminance sensor 340, and a display 360. According to an embodiment, the electronic device 301 may be implemented to be identical or similar to the electronic device 101 of FIG. 1.

According to an embodiment, the processor 320 may control the overall operation of the electronic device 301. The processor 320 may be implemented to be the same as or similar to the processor 120 of FIG. 1. According to an embodiment, the processor 320 may be an application processor (AP). According to an embodiment, the sensor hub 330 may control the illuminance sensor 340. According to an embodiment, at least some of the operations by the sensor hub 330 may also be controlled by the processor 320. According to an implementation, the sensor hub 330 may be excluded from the electronic device 301. In this case, the operations or functions of the sensor hub 330 may be performed by the processor 320.

According to an embodiment, the display 360 may be implemented to be identical or similar to the display module 160 of FIG. 2. For example, the display 360 may adjust the color temperature of the screen displayed through the display 360 based on external illuminance. For example, the display 360 may support an environment adaptive display (EAD) function.

According to an embodiment, the illuminance sensor 340 may be disposed on a lower end portion of the display 360. The illuminance sensor 340 may be implemented to support an environment adaptive display (EAD) function of the display 360. According to an embodiment, the illuminance sensor 340 may be implemented in an array form. For example, the illuminance sensor 340 may be implemented as an array in the form of X*Y (e.g., X is the number of columns, and Y is the number of rows). The illuminance sensor 340 may include a plurality of light receiving elements. For example, the plurality of light receiving elements may be arranged in RGB form according to rows or columns of the array. According to an embodiment, the illuminance sensor 340 may be implemented to be identical or similar to the sensor module 276 of FIG. 2.

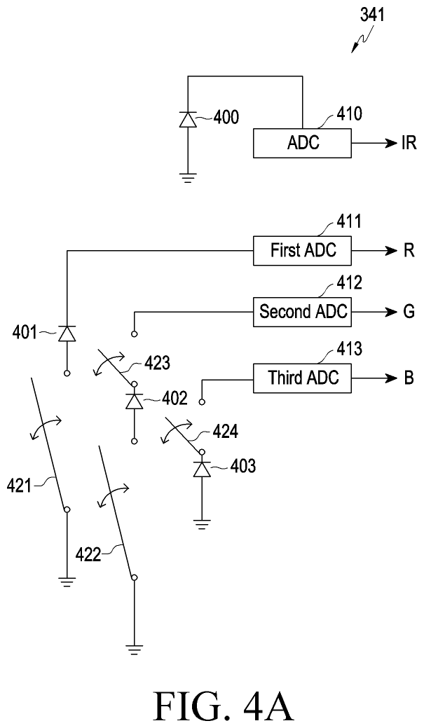

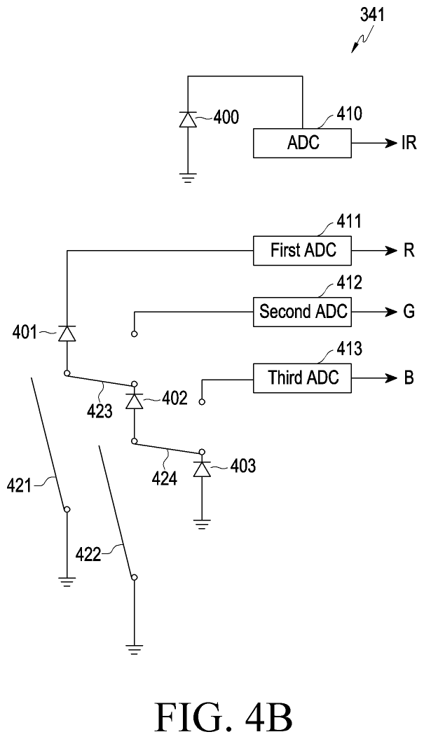

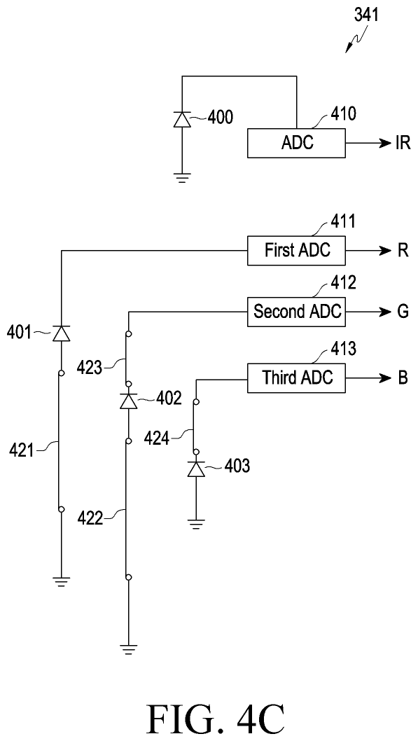

According to an embodiment, the first sensor array (341 of FIG. 4A) included in the illuminance sensor 340 may include a plurality of light receiving elements 400, 401, 402, and 403 of FIG. 4A, a plurality of analog-to-digital converters (ADCs) (410, 411, 412, and 413 of FIG. 4A), and a plurality of switches (421, 422, 423, and 424 of FIG. 4A). According to an embodiment, the illuminance sensor 340 may have a structure in which a plurality of first sensor arrays 341 are arranged.

According to an embodiment, each of the plurality of light receiving elements may generate and output a voltage corresponding to external light. For example, each of the plurality of light receiving elements may output a voltage corresponding to external light to the analog-to-digital converter (ADC) connected to each of the plurality of light receiving elements.

According to an embodiment, the plurality of light receiving elements may include a first light receiving element (401 of FIG. 4A) to sense light corresponding to red (R), a second light receiving element (402 of FIG. 4A) to sense light corresponding to green (G), a third light receiving element (403 of FIG. 4A) to sense light corresponding to blue (B), and an infrared (IR) light receiving element (400 of FIG. 4A) to sense light corresponding to infrared (IR). For example, the first light receiving element 401 may filter light in a wavelength band corresponding to red R from external light. For example, the first light receiving element 401 may include a filter for filtering the red R light. For example, the second light receiving element 402 may filter light in a wavelength band corresponding to green G from external light. For example, the second light receiving element 402 may include a filter for filtering the green G light. For example, the third light receiving element 403 may filter light in a wavelength band corresponding to blue from external light. For example, the third light receiving element 403 may include a filter for filtering the blue B light. For example, the first light receiving element 401 may obtain light in a wavelength band of about 550 nm to about 700 nm, the second light receiving element 402 may obtain light in a wavelength band of about 500 nm to about 650 nm, the third light receiving element 403 may obtain light in a wavelength band of about 400 nm to about 550 nm, and the light receiving element 400 may obtain light in a wavelength band of about 700 nm to about 1000 nm. However, this is an example, and the number of a plurality of light receiving elements is not limited. For example, the plurality of light receiving elements may include light receiving elements for sensing light of R, G, and B in one column or row. According to the implementation, the plurality of light receiving elements may further include at least one light receiving element for more precisely sensing specific light (e.g., R, G, or B) in one column or row. For example, the plurality of light receiving elements may be implemented in a form for sensing light corresponding to RGBB, RRGB, or RGBB in one column or row.

According to an embodiment, each of the plurality of light receiving elements may form a channel for sensing specific light (e.g., red, green, blue, and infrared) with an ADC that may be connected to each of the plurality of light receiving elements.

According to an embodiment, the plurality of ADCs may include an ADC (410 of FIG. 4A) corresponding to the light receiving element 400, a first ADC (411 of FIG. 4A) corresponding to the first light receiving element (401 of FIG. 4A), a second ADC (412 of FIG. 4A) corresponding to the second light receiving element 402, and a third ADC (413 of FIG. 4A) corresponding to the third light receiving element 403. According to an embodiment, the plurality of ADCs may convert a value (e.g., a voltage value) based on an analog electrical signal corresponding to the amount of light received from the plurality of light receiving elements into a digital value and output the same.

According to an embodiment, the processor 320 may determine or identify the ambient illuminance of the electronic device 301 based on the digital value output from at least one of the plurality of ADCs.

According to an embodiment, the illuminance sensor 340 may be driven in a first mode (e.g., short mode) and a second mode (e.g., long mode) under the control of the processor 320 to sense the ambient illuminance of the electronic device 301. For example, the first mode (e.g., short mode) may mean a driving mode of the illuminance sensor 340 in which the plurality of light receiving elements included in the illuminance sensor 340 are activated (or deactivated) every designated time during a first time period. The second mode (e.g., long mode) may mean a driving mode of the illuminance sensor 340 in which the plurality of light receiving elements included in the illuminance sensor 340 remain active during a second time period. For example, the first time period may mean a time period in which the illuminance sensor 340 operates in the first mode. The second time period may mean a time period in which the illuminance sensor 340 operates in the second mode. For example, the first time period and the second time period may be designated by the processor 320 or the user. For example, the first time period and the second time period may be a time period of about 16.6 ms or more. According to the implementation, the first time period and the second time period may be set to be the same or different from each other. For example, the first time period may be set to be longer than the second time period.

According to an embodiment, the processor 320 may control a plurality of switches (421, 422, 423, and 424 of FIG. 4A) to connect that the first light receiving element 401, the second light receiving element 402, and the third light receiving element 403 in series to any one of the first ADC 411, the second ADC 412, or the third ADC 413 in the first mode (e.g., short mode). According to an embodiment, in the first mode, the processor 320 may control the illuminance sensor 340 so that the plurality of light receiving elements are activated and deactivated every designated time during the first time period. For example, the plurality of light receiving elements may be activated and deactivated during the first time period. According to an embodiment, the illuminance sensor 340 may sense light for identifying the ambient illuminance of the electronic device 301 during a time period in which a plurality of light receiving elements are activated. According to an embodiment, the processor 320 may identify the first illuminance value using light sensed in a time period in which the time when the display 360 is turned off and the time period in which the plurality of light receiving elements are activated substantially match each other.

According to an embodiment, the processor 320 may identify the first voltage obtained by the first light receiving element 401, the second voltage obtained by the second light receiving element 402, and the third voltage obtained by the third light receiving element 403 in the first mode.

According to an embodiment, a fourth voltage obtained by adding the first voltage, the second voltage, and the third voltage may be input to the first ADC 411. According to an embodiment, if the fourth voltage is input to the first ADC 411, the first ADC 411 may obtain a fourth value based on the fourth voltage. According to an embodiment, the fourth value may be a digital value.

According to an embodiment, the sensor hub 330 may obtain the first illuminance value based on the fourth value based on the fourth voltage. The processor 320 may obtain the first illuminance value based on the fourth value based on the fourth voltage.

According to an embodiment, the processor 320 may execute the second mode (e.g., long mode) a preset time after the first mode ends. According to the implementation, the second mode may be executed before the first mode. According to an embodiment, the processor 320 may control the plurality of light receiving elements so that the plurality of light receiving elements remain active during the second time period in the second mode. According to an embodiment, the illuminance sensor 340 may sense light for identifying the ambient illuminance of the electronic device 301 during the second time period. According to an embodiment, the processor 320 may identify the second illuminance value using light sensed by the plurality of light receiving elements in a time period in which the display 360 is turned on and the second time period substantially match each other. Alternatively, according to an embodiment, the processor 320 may identify the second illuminance value using light sensed by the plurality of light receiving elements in a time period in which the display 360 is turned off and the second time period match each other. Alternatively, according to an embodiment, the processor 320 may identify the second illuminance value using light sensed by the plurality of light receiving elements at the time when the display 360 is turned on and the time when the display 360 is turned off.

According to an embodiment, the processor 320 may control the plurality of switches to connect the first light receiving element 401 to the first ADC 411, connect the second light receiving element 402 to the second ADC 412, and connect the third light receiving element 403 to the third ADC 413 in the second mode.

According to an embodiment, the processor 320 may identify the first voltage obtained by the first light receiving element 401, the second voltage obtained by the second light receiving element 402, and the third voltage obtained by the third light receiving element 403 in the second mode.

According to an embodiment, in the second mode, the first voltage obtained by the first light receiving element 401 may be input to the first ADC 411, the second voltage obtained by the second light receiving element 402 may be input to the second ADC 412, and the third voltage obtained by the third light receiving element 403 may be input to the third ADC 413.

According to an embodiment, the first ADC 411 may obtain the first value based on the first voltage, the second ADC 412 may obtain the second value based on the second voltage, and the third ADC 413 may obtain the third value based on the third voltage. According to an embodiment, the first value, the second value, and the third value may be digital values.

According to an embodiment, the sensor hub 330 may obtain and identify the second illuminance value based on the first value, the second value, and the third value. For example, the processor 320 may identify the second illuminance value through the sensor hub 330. Alternatively, the processor 320 may obtain and identify the second illuminance value based on the first value, the second value, and the third value without the sensor hub 330. According to the implementation, the processor 320 may obtain and identify the second illuminance value after obtaining the first value, the second value, and the third value from the sensor hub 330.

According to an embodiment, the processor 320 may compare the magnitude of the first illuminance value obtained in the first mode with the magnitude of the second illuminance value obtained in the second mode. According to an embodiment, the processor 320 may determine the illuminance value having a larger magnitude of the first illuminance value and the second illuminance value as an illuminance value around the electronic device 301 based on the comparison. According to an embodiment, the processor 320 may determine an average value of the first illuminance value and the second illuminance value as the illuminance value around the electronic device 301. According to an embodiment, the processor 320 may determine the illuminance value having a smaller magnitude of the first illuminance value and the second illuminance value as the illuminance value around the electronic device 301. This is an example, and embodiments of the disclosure may determine the illuminance value around the electronic device 301 in various ways.

According to an embodiment, the processor 320 may obtain a value related to the color temperature based on the first value, the second value, and the third value obtained in the second mode. According to an embodiment, the processor 320 may adjust the color of the screen displayed on the display 360 based on the value related to the color temperature.

At least some of the operations of the electronic device 301 described in the following drawings may be performed by the processor 320 or the sensor hub 330. However, for convenience of description, the operations performed by the processor 320 and/or the sensor hub 330 are described as being performed by the electronic device 301.

FIG. 3B is a graph illustrating a first mode and a second mode of an electronic device according to an embodiment of the disclosure.

Referring to FIG. 3B, part (a) of FIG. 3B is a duty cycle in which the display 360 (e.g., the display 360 of FIG. 3A) repeats turn-on and turn-off, and part (b) of FIG. 3B is a duty cycle in which the first and second modes of the illuminance sensor 340 (e.g., the illuminance sensor 340 of FIG. 3A) are repeated. The turn-on of the display 360 may mean that the display 360 emits light, and the turn-off of the display 360 may mean that the display 360 does not emit light.

Referring to part (a) of FIG. 3B, according to an embodiment, the display 360 may be turned on during the first time period T1 and turned off during the second time period T2. According to an embodiment, the turn-on or turn-off of the display 360 may be repeated every designated period. The designated period may mean a time period obtained by adding the first time period T1 and the second time period T2. For example, the designated period may be set to about 4.15 ms.

Referring to part (b) of FIG. 3B, according to an embodiment, the illuminance sensor 340 may be driven in the first mode for a third time period T3 (e.g., about 40 ms) and in the second mode for a fifth time period T5 (e.g., about 25 ms) under the control of the processor 320 (e.g., the processor 320 of FIG. 3A). For example, the first mode (e.g., short mode) may mean a driving mode of the illuminance sensor 340 in which the plurality of light receiving elements included in the illuminance sensor 340 are activated every designated time during the third time period T3. The second mode (e.g., long mode) may mean a driving mode of the illuminance sensor 340 in which the plurality of light receiving elements included in the illuminance sensor 340 remain active during the fifth time period T5. According to an embodiment, the illuminance sensor 340 may operate in the first mode or the second mode every designated period. The designated period may mean a time period obtained by adding the third time period T3, the fourth time period T4, the fifth time period T5, and the sixth time period T6.

According to an embodiment, the illuminance sensor 340 may be driven in the first mode (e.g., short mode) in which the plurality of light receiving elements are activated for a first time t1 (e.g., about 400 μs) designated in the third time period T3, and the plurality of light receiving elements are activated again after the second time t2. The number of times when the plurality of light receiving elements are activated in the third time period T3 may be determined by the capacity of the buffer (e.g., first-in-first-out (FIFO)) and the first time t1. The second time t2 may be determined based on the number of times of activation. For example, the number of times when the plurality of light receiving elements are activated may be about 80. For example, one time out of about 80 times may mean the first time t1. However, this is an example, and the number of times when the plurality of light receiving elements are activated may be different according to implementations. According to an embodiment, the illuminance sensor 340 may sense light for identifying the ambient illuminance of the electronic device 301 during a time period in which the plurality of light receiving elements included in the illuminance sensor 340 are activated in the third time period T3 (e.g., about 40 ms). According to an embodiment, the processor 320 may identify the first illuminance value of the electronic device 301 (e.g., the electronic device 301 of FIG. 3A) using light sensed by the plurality of light receiving elements in a time period in which the time period in which the display 360 is turned off and the time period in which the plurality of light receiving elements are activated substantially match each other. According to an embodiment, the designated first time t1 may mean a time shorter than the fifth time period T5 (e.g., about 25 ms).

According to an embodiment, the plurality of light receiving elements may be deactivated during a fourth time period T4 (e.g., about 10 ms) after the third time period T3.

According to an embodiment, the illuminance sensor 340 may be driven in a second mode (e.g., long mode) in which the plurality of light receiving elements remain active during a fifth time period T5 after the fourth time period T4. According to an embodiment, the illuminance sensor 340 may sense light for identifying the ambient illuminance of the electronic device 301 during the fifth time period T5. According to an embodiment, the processor 320 may identify the second illuminance value using light sensed by the plurality of light receiving elements in a time period in which the time period in which the display 360 is turned on and the fifth time period T5 substantially match each other. Alternatively, according to an embodiment, the processor 320 may identify the second illuminance value using light sensed by the plurality of light receiving elements in a time period in which the time period in which the display 360 is turned off and the fifth time period T5 substantially match each other. Alternatively, according to an embodiment, the processor 320 may identify the second illuminance value using light sensed by the plurality of light receiving elements in the time period in which the display 360 is turned on and the time period in which the display 360 is turned off.

According to an embodiment, the illuminance sensor 340 may be deactivated for the sixth time period T6 (e.g., about 25 ms) after the fifth time period T5.

According to an embodiment, the electronic device 301 may execute the second mode (e.g., long mode), a preset time after the time when the first mode ends. According to the implementation, the second mode may be executed before the first mode.

According to an embodiment, the electronic device 301 may determine the illuminance value of the electronic device 301 using the first illuminance value and the second illuminance value.

FIG. 4A is a circuit diagram illustrating a first sensor array according to an embodiment of the disclosure.

Referring to FIG. 4A, according to an embodiment, an illuminance sensor 340 (e.g., the illuminance sensor 340 of FIG. 3A) may be implemented in an array form. For example, the illuminance sensor 340 may be implemented as an array in the form of X*Y (e.g., X is the number of columns, and Y is the number of rows). The illuminance sensor 340 may include a plurality of light receiving elements. For example, the plurality of light receiving elements may be arranged in RGB form according to rows or columns of the array.

According to an embodiment, the first sensor array 341 included in the illuminance sensor 340 may include a plurality of light receiving elements for detecting light of different wavelengths, a plurality of analog-to-digital converters (ADCs) respectively corresponding to the plurality of light receiving elements, and a plurality of switches.

According to an embodiment, the first sensor array 341 may include a light receiving element 400, a first light receiving element 401, a second light receiving element 402, a third light receiving element 403, an ADC 410 corresponding to the light receiving element 400, a first ADC 411 corresponding to the first light receiving element 401, a second ADC 412 corresponding to the second light receiving element 402, a third ADC 413 corresponding to the third light receiving element 403, and a first switch 421, a second switch 422, a third switch 423, and a fourth switch 424.

For example, the first light receiving element 401 may filter light in a wavelength band corresponding to red R from external light. For example, the first light receiving element 401 may include a filter for filtering the red R light. For example, the second light receiving element 402 may filter light in a wavelength band corresponding to green G from external light. For example, the second light receiving element 402 may include a filter for filtering the green G light. For example, the third light receiving element 403 may filter light in a wavelength band corresponding to blue from external light. For example, the third light receiving element 403 may include a filter for filtering the blue B light. For example, the light receiving element 400 may filter light in a wavelength band corresponding to infrared (IR) from external light. For example, the first light receiving element 401 may obtain light in a wavelength band of about 550 nm to about 700 nm, the second light receiving element 402 may obtain light in a wavelength band of about 500 nm to about 650 nm, the third light receiving element 403 may obtain light in a wavelength band of about 400 nm to about 550 nm, and the light receiving element 400 may obtain light in a wavelength band of about 700 nm to about 1000 nm.

According to an embodiment, the first switch 421 may be disposed between the ground and one end of the first light receiving element 401. In this case, the other end of the first light receiving element 401 may be connected to the first ADC 411.

According to an embodiment, the second switch 422 may be disposed between the ground and one end of the second light receiving element 402.

According to an embodiment, the third switch 423 may connect one end of the first light receiving element 401 to the other end of the second light receiving element 402 or connect the other end of the second light receiving element 402 to the second ADC 412.

According to an embodiment, the fourth switch 424 may connect one end of the second light receiving element 402 to the other end of the third light receiving element 403 or connect the other end of the third light receiving element 403 to the third ADC 413. In this case, one end of the third light receiving element 403 may be connected to the ground.

FIG. 4B is a circuit diagram illustrating a first sensor array when an electronic device is in a first mode according to an embodiment of the disclosure.

Referring to FIG. 4B, according to an embodiment, the electronic device 301 (e.g., the electronic device 301 of FIG. 3A) may control the first switch 421, the second switch 422, the third switch 423, and the fourth switch 424 to connect the first light receiving element 401, the second light receiving element 402, and the third light receiving element 403 in series to the first ADC 411 in the first mode (e.g., short mode) in which the plurality of light receiving elements are activated every designated time during a first time period.

According to an embodiment, the electronic device 301 may open the first switch 421 not to connect the ground to one end of the first light receiving element 401. According to an embodiment, the electronic device 301 may open the second switch 422 not to connect the ground to one end of the second light receiving element 402.

According to an embodiment, the electronic device 301 may control the third switch 423 to connect one end of the first light receiving element 401 to the other end of the second light receiving element 402. According to an embodiment, the electronic device 301 may control the fourth switch 424 to connect one end of the second light receiving element 402 to the other end of the third light receiving element 403.

Accordingly, the other end of the first light receiving element 401 may be connected to the first ADC 411, one end of the first light receiving element 401 may be connected to the other end of the second light receiving element 402, one end of the second light receiving element 402 may be connected to the other end of the third light receiving element 403, and one end of the third light receiving element 403 may be connected to the ground.

According to an embodiment, the first light receiving element 401 may obtain the first voltage, the second light receiving element 402 may obtain the second voltage, and the third light receiving element 403 may obtain the third voltage. According to an embodiment, a fourth voltage obtained by adding the first voltage, the second voltage, and the third voltage may be input to the first ADC 411. According to an embodiment, the first ADC 411 may output the fourth value based on the input of the fourth voltage. The fourth value may mean a digital value.

According to an embodiment, the first ADC 411 may transmit the fourth value to the sensor hub 330 (e.g., the sensor hub 330 of FIG. 3A). According to an embodiment, the sensor hub 330 may obtain the first illuminance value of the electronic device 301 based on the fourth value. According to an embodiment, the processor 320 (e.g., the processor 320 of FIG. 3A) may obtain the first illuminance value of the electronic device 301 based on the fourth value.

The electronic device 301 may obtain a first illuminance value other than 0 in low illuminance based on the total voltage obtained by the plurality of light receiving elements 401, 402, and 403 being input to the first ADC 411. The electronic device 301 may obtain a more accurate first illuminance value.

FIG. 4C is a circuit diagram illustrating a first sensor array when an electronic device is in a second mode according to an embodiment of the disclosure.

Referring to FIG. 4C, according to an embodiment, the electronic device 301 (e.g., the electronic device 301 of FIG. 3A) may control the first switch 421, the second switch 422, the third switch 423, and the fourth switch 424 so that the first light receiving element 401 is connected to the first ADC 411, the second light receiving element 402 is connected to the second ADC 412, and the third light receiving element 403 is connected to the third ADC 413 in the second mode (e.g., long mode) in which the plurality of light receiving elements remain active during the second time period.

According to an embodiment, the electronic device 301 may short the first switch to connect the ground to one end of the first light receiving element 401. According to an embodiment, the electronic device 301 may short the second switch 422 to connect the ground to one end of the second light receiving element 402. According to an embodiment, the electronic device 301 may control the third switch 423 to connect the other end of the second light receiving element 402 to the second ADC 412. According to an embodiment, the electronic device 301 may control the fourth switch 424 to connect the other end of the third light receiving element 403 to the third ADC 413.

According to an embodiment, the plurality of light receiving elements 401, 402, and 403 may detect light having different wavelengths.

According to an embodiment, the first light receiving element 401 may obtain the first voltage based on light, the second light receiving element 402 may obtain the second voltage based on light, and the third light receiving element 403 may obtain the third voltage based on light. According to an embodiment, the first ADC 411 may output the first value based on the input of the first voltage. According to an embodiment, the second ADC 412 may output the second value based on the input of the second voltage. According to an embodiment, the third ADC 413 may output the third value based on the input of the third voltage. The first value, the second value, and the third value may mean digital values.

According to an embodiment, the electronic device 301 may identify the second illuminance value of the electronic device 301 based on the sum of the first value, the second value, and the third value.

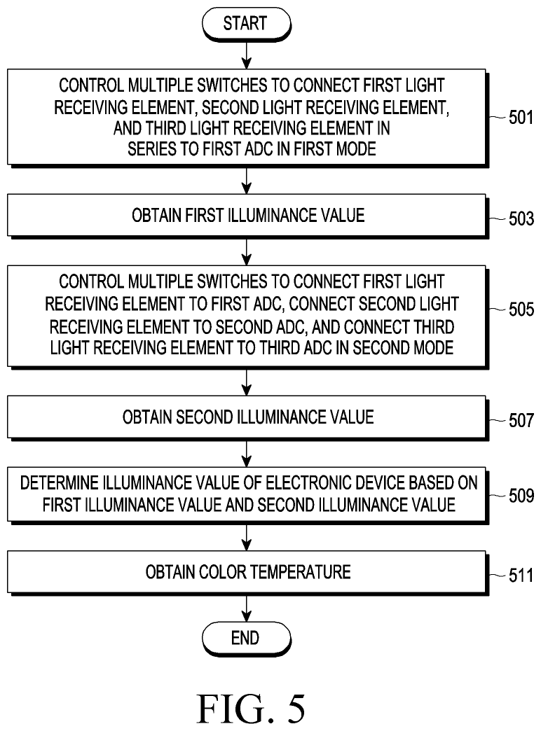

FIG. 5 is a flowchart illustrating an operation of obtaining a value related to a color temperature and an illuminance value by an electronic device according to an embodiment of the disclosure.

In the following embodiment, each operation may be sequentially performed, but is not necessarily performed sequentially. For example, the order of the operations may be changed, and at least two operations may be performed in parallel.

According to an embodiment, it may be understood that operations 501 to 511 are performed by a processor (e.g., the processor 320 of FIG. 3A) of an electronic device (e.g., the electronic device 301 of FIG. 3A).

Referring to FIG. 5, according to an embodiment, an illuminance sensor 340 (e.g., the illuminance sensor 340 of FIG. 3A) may be implemented in an array form. According to an embodiment, the illuminance sensor 340 may have a structure in which a plurality of first sensor arrays 341 (e.g., the first sensor array 341 of FIG. 4A) are disposed.

According to an embodiment, in operation 501, the electronic device 301 (e.g., the electronic device 301 of FIG. 3A) may control the plurality of switches (e.g., the first switch 421 of FIG. 4A, the second switch 422 of FIG. 4A, the third switch 423 of FIG. 4A, and the fourth switch 424 of FIG. 4A) to connect the first light receiving element 401 (e.g., the first light receiving element 401 of FIG. 4A), the second light receiving element 402 (e.g., the second light receiving element 402 of FIG. 4A), and the third light receiving element 403 (e.g., the third light receiving element 403 of FIG. 4A) in series to the first ADC 411 (e.g., the first ADC 411 of FIG. 4A) in the first mode (e.g., short mode). According to an embodiment, the illuminance sensor 340 may be activated every designated time during the first time interval in the first mode. According to an embodiment, the illuminance sensor 340 may sense light for identifying the ambient illuminance of the electronic device 301 in a time period in which the illuminance sensor 340 is activated.

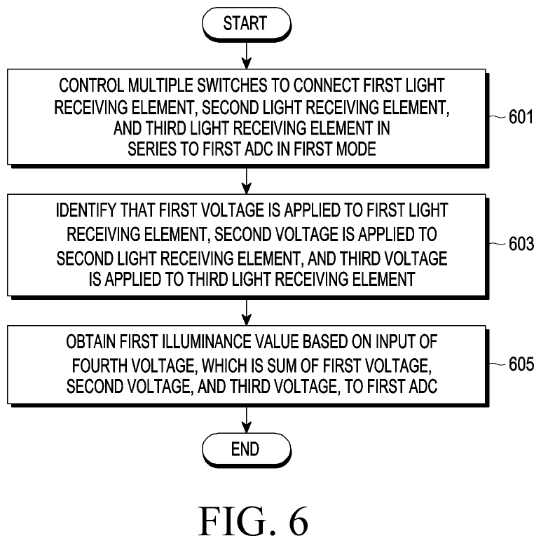

According to an embodiment, in operation 503, the electronic device 301 may obtain the first illuminance value in the first mode. According to an embodiment, the electronic device 301 may obtain (or identify) the first illuminance value of the electronic device 301 using light sensed by the illuminance sensor 340 in a time interval in which the time when the display 360 (e.g., the display 360 of FIG. 3A) is turned off and the time when the illuminance sensor 340 is activated substantially match each other. According to an embodiment, the electronic device 301 may obtain the first illuminance value based on the voltage obtained by the first light receiving element 401, the voltage obtained by the second light receiving element 402, and the voltage obtained by the third light receiving element 403 being input to the first ADC 411. According to an embodiment, the operation in which the electronic device 301 obtains the first illuminance value in the first mode is described in detail with reference to FIG. 6.

According to an embodiment, in operation 505, the electronic device 301 may control the first switch 421, the second switch 422, the third switch 423, and the fourth switch 424 to connect the first light receiving element 401 to the first ADC 411, connect the second light receiving element 402 to the second ADC 412, and connect the third light receiving element 403 to the third ADC 413 in the second mode. According to an embodiment, the illuminance sensor 340 may be activated for a second time period in the second mode.

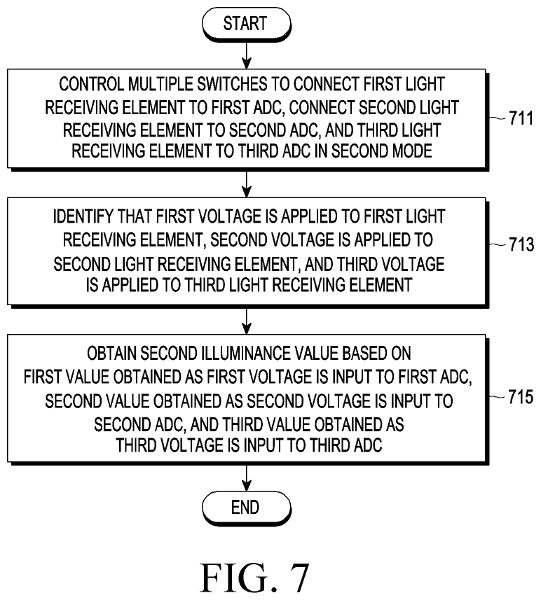

According to an embodiment, in operation 507, the electronic device 301 may obtain and identify the second illuminance value in the second mode. According to an embodiment, the electronic device 301 may identify the second illuminance value of the electronic device 301 using light sensed by the illuminance sensor 340 in a time period in which the display 360 is turned on and the time period in which the time period in which the display 360 is turned on and the time period in which the illuminance sensor 340 is activated substantially match each other. Alternatively, according to an embodiment, the electronic device 301 may identify the second illuminance value of the electronic device 301 using light sensed by the illuminance sensor 340 in a time period in which the time period in which the display 360 is turned off and the time period in which the illuminance sensor 340 is activated substantially match each other. Alternatively, according to an embodiment, the electronic device 301 may identify the second illuminance value of the electronic device 301 using light sensed by the plurality of light receiving elements in the time period in which the display 360 is turned on and the time period in which the display 360 is turned off. According to an embodiment, the electronic device 301 may obtain the second illuminance value based on the voltage obtained by the first light receiving element 401 being input to the first ADC 411, the voltage obtained by the second light receiving element 402 being input to the second ADC 412, and the third voltage obtained by the third light receiving element 403 being input to the third ADC 413. According to an embodiment, the operation in which the electronic device 301 obtains the second illuminance value in the second mode is described in detail with reference to FIG. 7.

According to an embodiment, in operation 509, the electronic device 301 may determine the illuminance value around the electronic device 301 based on the first illuminance value and the second illuminance value. According to an embodiment, the electronic device 301 may compare the first illuminance value and the second illuminance value. According to an embodiment, the electronic device 301 may determine the illuminance value having a larger magnitude of the first illuminance value and the second illuminance value as an illuminance value around the electronic device 301 based on the comparison. According to an embodiment, the electronic device 301 may determine an average value of the first illuminance value and the second illuminance value as the illuminance value of the electronic device 301. According to an embodiment, the electronic device 301 may determine the illuminance value having a smaller magnitude of the first illuminance value and the second illuminance value as the illuminance value of the electronic device 301. This is an example, and embodiments of the disclosure may determine the illuminance value around the electronic device 301 in various ways.

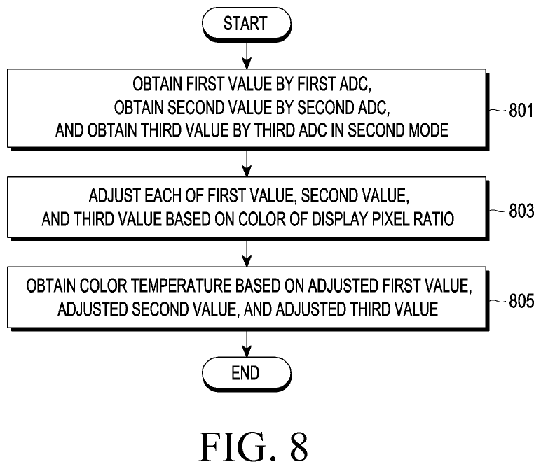

According to an embodiment, in operation 511, the electronic device 301 may obtain a value related to the color temperature based on the determined illuminance value. According to an embodiment, the electronic device 301 may obtain a value related to a color temperature based on digital values obtained in the second mode. In the second mode, the electronic device 301 may obtain the value related to the color temperature, based on the first value output based on the voltage obtained by the first light receiving element 401 being input to the first ADC 411, the second value output based on the voltage obtained by the second light receiving element 402 being input to the second ADC 412, and the third value output based on the voltage obtained by the third light receiving element 403 being input to the third ADC 413. According to an embodiment, the electronic device 301 may adjust the color of the screen of the display 360 based on the value related to the color temperature. According to an embodiment, an operation of the electronic device 301 to obtain the value related to the color temperature is described in detail with reference to FIG. 8.

According to an embodiment, the electronic device 301 may identify the illuminance value around the electronic device 301 every designated period. Further, the electronic device 301 may obtain the value related to the color temperature and adjust the color of the screen of the display 360 based on the illuminance value identified every designated period.

According to an embodiment, after operations 505, 507, 509, and 511 are performed, operations 501 and 503 may be performed.

FIG. 6 is a flowchart illustrating an operation of obtaining a first illuminance value when an electronic device is in a first mode according to an embodiment of the disclosure.

In the following embodiment, each operation may be sequentially performed, but is not necessarily performed sequentially. For example, the order of the operations may be changed, and at least two operations may be performed in parallel.

According to an embodiment, it may be understood that operations 601 to 605 are performed by a processor (e.g., the processor 320 of FIG. 3A) of an electronic device (e.g., the electronic device 301 of FIG. 3A).

Referring to FIG. 6, according to an embodiment, an illuminance sensor 340 (e.g., the illuminance sensor 340 of FIG. 3A) may be disposed on a lower end of the display 360 (e.g., the display 360 of FIG. 3A). According to an embodiment, the electronic device 301 may drive the illuminance sensor 340 in a first mode (e.g., short mode) in which the plurality of light receiving elements included in the illuminance sensor 340 are activated every designated time during the first time period and a second mode (e.g., long mode) in which the plurality of light receiving elements remain active during the second time period.

According to an embodiment, in operation 601, the electronic device 301 (e.g., the electronic device 301 of FIG. 3A) may control the plurality of switches (e.g., the first switch 421 of FIG. 4A, the second switch 422 of FIG. 4A, the third switch 423 of FIG. 4A, and the fourth switch 424 of FIG. 4A) to connect the first light receiving element 401 (e.g., the first light receiving element 401 of FIG. 4A), the second light receiving element 402 (e.g., the second light receiving element 402 of FIG. 4A), and the third light receiving element 403 (e.g., the third light receiving element 403 of FIG. 4A) in series to the first ADC 411 (e.g., the first ADC 411 of FIG. 4A) in the first mode. For example, the first light receiving element 401 may include a filter for filtering light in a wavelength band corresponding to red (R). According to an embodiment, the first light receiving element 401 may obtain light in a wavelength band of about 550 nm to about 700 nm. For example, the second light receiving element 402 may include a filter for filtering light in a wavelength band corresponding to green (G). According to an embodiment, the second light receiving element 402 may obtain light in a wavelength band of about 500 nm to about 650 nm. According to an embodiment, the third light receiving element 403 may include a filter for filtering light in a wavelength band corresponding to blue (B). According to an embodiment, the third light receiving element 403 may obtain light in a wavelength band of about 400 nm to about 550 nm.

According to an embodiment, the electronic device 301 may open the first switch 421 not to connect the ground to one end of the first light receiving element 401 in the first mode. According to an embodiment, the electronic device 301 may open the second switch 422 not to connect the ground to one end of the second light receiving element 402 in the first mode. According to an embodiment, the electronic device 301 may control the third switch 423 to connect one end of the first light reception element 401 to the other end of the second light receiving element 402 in the first mode. According to an embodiment, the electronic device 301 may control the fourth switch 424 to connect one end of the second light reception element 402 to the other end of the third light receiving element 403 in the first mode.

According to an embodiment, in operation 603, the electronic device 301 may identify that the first voltage is applied to the first light receiving element 401, the second voltage is applied to the second light receiving element 402, and the third voltage is applied to the third light receiving element 403. The first voltage may mean a voltage based on light incident on the first light receiving element 401, the second voltage may mean a voltage based on light incident on the second light receiving element 402, and the third voltage may mean a voltage based on light incident on the third light receiving element 403.

According to an embodiment, in operation 605, the electronic device 301 may obtain the first illuminance value based on the input of the fourth voltage obtained by adding the first voltage, the second voltage, and the third voltage to the first ADC 411. According to an embodiment, the fourth voltage may be input to the first ADC 411, and the first ADC 411 may output the fourth value. According to an embodiment, the fourth value may mean a digital value. According to an embodiment, the electronic device 301 may obtain the first illuminance value based on the fourth value. Table 1 below is a table for describing an operation of obtaining a first illuminance value when an electronic device 301 according to an embodiment is in the first mode and an operation of obtaining a first illuminance value when an electronic device according to a comparative embodiment is in the first mode.

TABLE 1

| | | first light | second light | third light |
|---|---|---|---|---|
| | | receiving | receiving | receiving |
| | | element | element | element |
| comparative | voltage | 0.69 | 0.69 | 0.69 |
| embodiment | output value by | 0 | 0 | 0 |
| | ADC | | | |
| | final output | 0 | | |
| | value | | | |
| embodiment of | voltage | 0.69 | 0.69 | 0.69 |
| the disclosure | total voltage | 2.07 | | |
| | value (sum of | | | |
| | voltages) | | | |
| | output value by | 2 | | |
| | ADC | | | |
| | final output | 2 | | |
| | value | | | |

Referring to Table 1, according to an embodiment, the electronic device 301 (e.g., the electronic device 301 of FIG. 3A) may connect the first light receiving element 401 (e.g., the first light receiving element 401 of FIG. 4A), the second light receiving element 402 (e.g., the second light receiving element 402 of FIG. 4A), and the third light receiving element 403 (e.g., the third light receiving element 403 of FIG. 4A) in series to the first ADC 411 (e.g., the first ADC 411 of FIG. 4A) in the first mode (e.g., short mode). According to an embodiment, a total voltage value (e.g., 2.07V) obtained by adding a voltage value (e.g., about 0.69V) obtained by the first light receiving element 401, a voltage value (e.g., about 0.69V) obtained by the second light receiving element 402, and a voltage value (e.g., about 0.69V) obtained by the third light receiving element 403 may be input to the first ADC 411. According to an embodiment, the electronic device 301 may determine the digital value of the total voltage value as an output value by the ADC and a final output value. According to an embodiment, the first ADC 411 may output a digital value (e.g., 2) based on the input of the total voltage value. According to an embodiment, the electronic device 301 may determine the digital value as an output value by the ADC and a final output value. According to an embodiment, the electronic device 301 may obtain the first illuminance value of the electronic device 301 based on the final output value (e.g., 2) output by the first ADC 411. According to the comparative embodiment, the electronic device may, in the first mode, connect the first light receiving element to the first ADC corresponding to the first light receiving element, connect the second light receiving element to the second ADC corresponding to the second light receiving element, and connect the third light receiving element to the third ADC corresponding to the third light receiving element. According to the comparative embodiment, the electronic device may obtain a value of 0 by the first ADC based on a value of about 0.69 being input to the first ADC. According to the comparative embodiment, the electronic device may obtain a value of 0 by the second ADC based on a value of about 0.69 being input to the second ADC. According to the comparative embodiment, the electronic device may obtain a value of 0 by the third ADC based on a value of about 0.69 being input to the third ADC. According to the comparative embodiment, the electronic device may determine the sum of the digital value obtained by the first ADC, the digital value obtained by the second ADC, and the digital value obtained by the third ADC as the final output value. According to the comparative embodiment, the electronic device may determine the final output value as 0 based on the sum of digital values obtained by the first ADC, the second ADC, and the third ADC being 0. According to the comparative embodiment, the electronic device may obtain 0 as the first illuminance value based on the sum of digital values obtained by the first ADC, the second ADC, and the third ADC being 0. In other words, according to the comparative example, the electronic device may not measure or obtain an appropriate first illuminance value in the first mode.

According to the comparative embodiment, since the electronic device determines the first illuminance value based on the total digital value obtained by adding the digital values obtained by the respective ADCs, the electronic device obtains a first illuminance value of 0 in the low illuminance. According to an embodiment, the electronic device 301 may obtain a first illuminance value other than 0 even in a low illuminance based on the total voltage value obtained by adding the voltages obtained by the first light receiving element 401, the second light receiving element 402, and the third light receiving elements 403 being input to the first ADC 411. When the illuminance sensor 340 is driven in the first mode, the electronic device 301 according to an embodiment may obtain a first illuminance value other than 0 even in a low illuminance state.

FIG. 7 is a flowchart illustrating an operation of obtaining a second illuminance value when an electronic device is in a second mode according to an embodiment of the disclosure.

In the following embodiment, each operation may be sequentially performed, but is not necessarily performed sequentially. For example, the order of the operations may be changed, and at least two operations may be performed in parallel.

According to an embodiment, it may be understood that operations 711 to 715 are performed by a processor (e.g., the processor 320 of FIG. 3A) of an electronic device (e.g., the electronic device 301 of FIG. 3A).

Referring to FIG. 7, according to an embodiment, in operation 711, the electronic device 301 (e.g., the electronic device 301 of FIG. 3A) may control the plurality of switches (e.g., the first switch 421 of FIG. 4A, the second switch 422 of FIG. 4A, the third switch 423 of FIG. 4A, and the fourth switch 424) to connect the first light receiving element 401 (e.g., the first light receiving element 401 of FIG. 4A) to the first ADC 411 (e.g., the first ADC 411 of FIG. 4A), connect the second light receiving element 402 (e.g., the second light receiving element 402 of FIG. 4A) to the second ADC 412 (e.g., the second ADC 412 of FIG. 4A), and connect the third light receiving element 403 (e.g., the third light receiving element 403 of FIG. 4A) to the third ADC 413 (e.g., the third ADC 413 of FIG. 4A) in the second mode (e.g., long mode). According to an embodiment, the electronic device 301 may short the first switch 421 to connect the ground to one end of the first light receiving element 401. According to an embodiment, the electronic device 301 may short the second switch 422 to connect the ground to one end of the second light receiving element 402. According to an embodiment, the electronic device 301 may control the third switch 423 to connect the other end of the second light receiving element 402 to the second ADC 412. According to an embodiment, the electronic device 301 may control the fourth switch 424 to connect the other end of the third light receiving element 403 to the third ADC 413.

According to an embodiment, in operation 713, the electronic device 301 may identify that the first voltage is applied to the first light receiving element 401, the second voltage is applied to the second light receiving element 402, and the third voltage is applied to the third light receiving element 403. The first voltage may mean a voltage based on light incident on the first light receiving element 401, the second voltage may mean a voltage based on light incident on the second light receiving element 402, and the third voltage may mean a voltage based on light incident on the third light receiving element 403.

According to an embodiment, in operation 715, the electronic device 301 may obtain a second illuminance value based on the first value obtained by inputting the first voltage to the first ADC 411, the second value obtained by inputting the second voltage to the second ADC 412, and the third voltage obtained by inputting the third voltage to the third ADC 413. According to an embodiment, the first voltage may be input to the first ADC 411, and the first ADC 411 may output the first value. According to an embodiment, the second voltage may be input to the second ADC 412, and the second ADC 412 may output the second value. According to an embodiment, the third voltage may be input to the third ADC 413, and the third ADC 413 may output the third value. According to an embodiment, the first value, the second value, and the third value may mean digital values. According to an embodiment, the electronic device 301 may obtain and identify the second illuminance value based on the first value, the second value, and the third value.

FIG. 8 is a flowchart illustrating an operation of obtaining a value related to a color temperature by an electronic device according to an embodiment of the disclosure.

In the following embodiment, each operation may be sequentially performed, but is not necessarily performed sequentially. For example, the order of the operations may be changed, and at least two operations may be performed in parallel.

According to an embodiment, it may be understood that operations 801 to 805 are performed by a processor (e.g., the processor 320 of FIG. 3A) of an electronic device (e.g., the electronic device 301 of FIG. 3A).

Referring to FIG. 8, according to an embodiment, in operation 801, the electronic device 301 (e.g., the electronic device 301 of FIG. 3A) may obtain the first value by the first ADC 411 (e.g., the first ADC 411 of FIG. 4A), obtain the second value by the second ADC 412 (e.g., the second ADC 412 of FIG. 4A), and obtain the third value by the third ADC 413 (e.g., the third ADC 413 of FIG. 4A) in the second mode (e.g., long mode).

According to an embodiment, in operation 803, the electronic device 301 may adjust each of the first value, the second value, and the third value based on the color of the pixel ratio of the display 360 (e.g., the display 360 of FIG. 3A). According to an embodiment, the electronic device 301 may obtain parameter information related to a color on pixel ratio (COPR) of the display 360. The color on pixel ratio (COPR) may mean a ratio of the R (red) value, the G (green) value, and the B (blue) value of the plurality of pixels of the display 360. According to an embodiment, the electronic device 301 may adjust each of the first value, the second value, and the third value based on parameter information related to the color on pixel ratio (COPR).

According to an embodiment, in operation 805, the electronic device 301 may obtain a color temperature based on the adjusted first value, the adjusted second value, and the adjusted third value.

According to an embodiment, the electronic device 301 may obtain the color temperature Kc using Equation 1 below.

$$color temperature ( {K}_{c} ) = a \times \frac{max ( \frac{{R}_{ADC}}{{R}_{Ref}} , \frac{{G}_{ADC}}{{G}_{Ref}} , \frac{{B}_{ADC}}{{B}_{Ref}} )}{{R}_{ADC} + {G}_{ADC} + {B}_{ADC}} + b \qquad Equation 1$$

Equation 1 above is merely an example for helping understanding and, without limitations thereto, may be modified, applied, or expanded in various ways.

a and b are compensation coefficients based on the color on pixel ratio (COPR) and may mean constant values. R_ADC may mean the adjusted first value, G_ADC may mean the adjusted second value, and B_ADC may mean the adjusted third value. R_Ref may mean the digital value obtained by the first ADC 411 when the standard light is incident on the first light receiving element 401 in the second mode. G_Ref may mean the digital value obtained by the second ADC 412 when the standard light is incident on the second light receiving element 402 in the second mode. B_Ref may mean the digital value obtained by the third ADC 413 when the standard light is incident on the third light receiving element 403 in the second mode. The standard light may mean a light source having a value related to a color temperature larger than about 4000 K (Calvin), and less than or equal to about 5000 K (Calvin).

According to an embodiment, the electronic device 301 may adjust the color of the screen of the display 360 based on the color temperature. For example, the electronic device 301 may provide or support the EAD function of the display 360 based on the color temperature.

The electronic device 301 according to an embodiment may enhance the color temperature division power (or color temperature resolution) for external light of the illuminance sensor 340, thereby more effectively providing the EAD function of the display 360. Accordingly, the electronic device 301 may provide comfortable visibility to the user.

According to an embodiment, the electronic device 301 may adjust the color of the currently displayed screen of the display 360 according to the value related to the color temperature. Table 2 below is a table for describing the color of the screen corresponding to the value related to the color temperature.

TABLE 2

| color representation | color temperature |
|---|---|
| red | 4000 or less |
| not adjusted | 4000 to 5000 |
| blue | 5000 or more |

Referring to Table 2, according to an embodiment, if a value related to a color temperature of about 4000 K (Calvin) or less is obtained, the electronic device 301 may adjust the color of the currently displayed screen of the display 360 to red. According to an embodiment, the electronic device 301 may control the display 360 to turn on red pixels included in the display 360. According to an embodiment, if a value related to a color temperature larger than about 4000K and less than or equal to about 5000K is obtained, the electronic device 301 may not adjust the color of the display 360.

According to an embodiment, if a value related to a color temperature larger than about 5000K is obtained, the electronic device 301 may adjust the color of the currently displayed screen of the display 360 to blue. According to an embodiment, the electronic device 301 may control the display 360 to turn on blue pixels included in the display 360.

According to the above-described method, the electronic device 301 may enhance the color temperature division power (or color temperature resolution) for external light of the illuminance sensor 340, thereby more effectively providing the EAD function of the display 360. Accordingly, the electronic device 301 may provide comfortable visibility to the user.

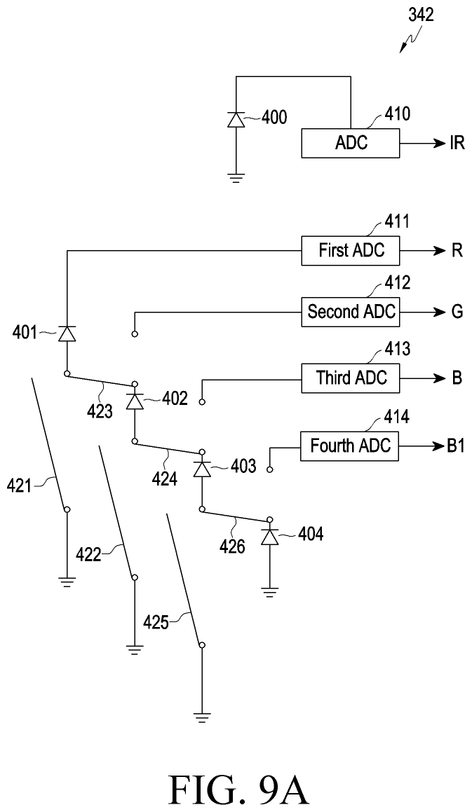

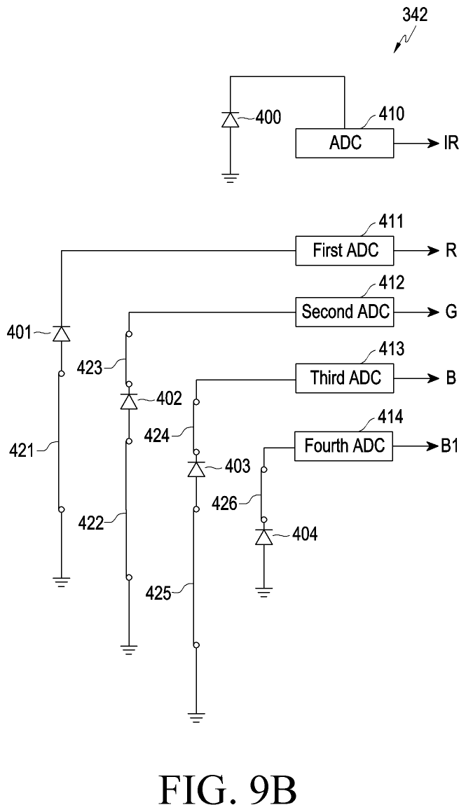

FIG. 9A is a circuit diagram illustrating a second sensor array when an electronic device is in a first mode according to an embodiment of the disclosure.

According to an embodiment, the plurality of light receiving elements of the electronic device 301 (e.g., the electronic device 301 of FIG. 3A) may include light receiving elements for sensing the light of red (R), green (G), and blue (B) in one column or row. According to the implementation, the plurality of light receiving elements may further include at least one light receiving element for more precisely sensing specific light (e.g., R, G, or B) in one column or row. For example, the plurality of light receiving elements may be implemented in a form for sensing light corresponding to R, G, B, and B1 in one column or row. For example, light corresponding to B may mean light in a wavelength band of about 500 nm to about 650 nm. For example, light corresponding to B1 may mean light in a wavelength band of about 450 nm to about 550 nm.

Referring to FIG. 9A, according to an embodiment, the illuminance sensor 340 (e.g., the illuminance sensor 340 of FIG. 3A) may be implemented in an array form. The second sensor array 342 included in the illuminance sensor 340 may include a light receiving element 400, a first light receiving element 401, a second light receiving element 402, a third light receiving element 403, an ADC 410, a first ADC 411, a second ADC 412, a third ADC 414, a first switch 421, a third switch 423, a fourth switch 424, a fifth switch 425, and a sixth switch 426. The second sensor array 342 may further include a fourth light receiving element 404, a fourth ADC 414 corresponding to the fourth light receiving element 404, a fifth switch 425, and a sixth switch 426 in addition to the plurality of elements (e.g., light receiving elements or switches) included in the first sensor array 341.

The fifth switch 425 may be disposed between the ground and the third light receiving element 403. The sixth switch 426 may connect one end of the third light receiving element 403 to the other end of the fourth light receiving element 404, or may connect the other end of the fourth light receiving element 404 to the fourth ADC 414. One end of the fourth light receiving element 404 may be connected to the ground.

For example, the first light receiving element 401 may include a filter for filtering the red R light. For example, the second light receiving element 402 may include a filter for filtering the green G light. For example, the third light receiving element 403 may include a filter for filtering the blue B light. For example, the fourth light receiving element 404 may include a filter for filtering the blue B1 light. For example, the first light receiving element 401 may obtain light in a wavelength band of about 550 nm to about 700 nm, and the second light receiving element 402 may obtain light in a wavelength band of about 500 nm to about 650 nm. For example, the third light receiving element 403 may obtain light in a wavelength band of about 400 nm to about 500 nm. The fourth light receiving element 404 may obtain light in a wavelength band of about 450 nm to about 550 nm. The wavelength band of light obtained by the third light receiving element 403 and the wavelength band of light obtained by the fourth light receiving element 404 may at least partially match each other. The wavelength band of light obtained by the third light receiving element 403 and the wavelength band of light obtained by the fourth light receiving element 404 may be different from each other. According to an embodiment, the electronic device 301 may sense the light corresponding to the blue B and B1 more precisely as the wavelength band of the blue light B obtained by the third light receiving element 403 and the wavelength band of the blue light B1 obtained by the fourth light receiving element 404 are at least partially different. According to an embodiment, the electronic device 301 may enhance color temperature division power (or color temperature resolution) of blue light with respect to external light.

However, this is an example, and the fourth light receiving element 404 may include a filter for filtering red (R) light or a filter for filtering green (G) light.

According to an embodiment, the electronic device 301 may control the first switch 421, the second switch 422, the third switch 423, the fourth switch 424, the fifth switch 425, and the sixth switch 426 to connect the first light receiving element 401, the second light receiving element 402, the third light receiving element 403, and the fourth light receiving element 404 in series to the first ADC 411 in the first mode (e.g., short mode).

According to an embodiment, the electronic device 301 may open the first switch 421 not to connect the ground to one end of the first light receiving element 401. According to an embodiment, the electronic device 301 may open the second switch 422 not to connect the ground to one end of the second light receiving element 402. According to an embodiment, the electronic device 301 may open the fifth switch 425 not to connect the ground to one end of the third light receiving element 403.

According to an embodiment, the electronic device 301 may control the third switch 423 to connect one end of the first light reception element 401 to the other end of the second light receiving element 402. According to an embodiment, the electronic device 301 may control the fourth switch 424 to connect one end of the second light reception element 402 to the other end of the third light receiving element 403. According to an embodiment, the electronic device 301 may control the sixth switch 426 to connect one end of the third light reception element 403 to the other end of the fourth light receiving element 404.

According to an embodiment, the first light receiving element 401 may obtain the first voltage, the second light receiving element 402 may obtain the second voltage, the third light receiving element 403 may obtain the third voltage, and the fourth light receiving element 404 may obtain the fourth voltage. According to an embodiment, a fifth voltage obtained by adding the first voltage, the second voltage, the third voltage, and the fourth voltage may be input to the first ADC 411. According to an embodiment, the first ADC 411 may output the fifth value based on the input of the fifth voltage. The fifth value may mean a digital value.

According to an embodiment, the first ADC 411 may transmit the fifth value to the sensor hub 330. According to an embodiment, the sensor hub 330 may obtain the first illuminance value of the electronic device 301 based on the fifth value.

As the fifth voltage obtained by adding the first voltage, the second voltage, the third voltage, and the fourth voltage is input to the first ADC 411, the electronic device 301 may obtain a first illuminance value other than 0 in the low illuminance.

FIG. 9B is a circuit diagram illustrating an illuminance sensor in a second mode according to an embodiment of the disclosure.

Referring to FIG. 9B, according to an embodiment, the electronic device 301 (e.g., the electronic device 301 of FIG. 3A) may control the first switch 421, the second switch 422, the third switch 423, the fourth switch 424, the fifth switch 425, and the sixth switch 426 so that the first light receiving element 401 is connected to the first ADC 411, the second light receiving element 402 is connected to the second ADC 412, the third light receiving element 403 is connected to the third ADC 413, and the fourth light receiving element 404 is connected to the fourth ADC 414 in the second mode (e.g., long mode).

According to an embodiment, the electronic device 301 may short the first switch 421 to connect the ground to one end of the first light receiving element 401. According to an embodiment, the electronic device 301 may short the second switch 422 to connect the ground to one end of the second light receiving element 402. According to an embodiment, the electronic device 301 may short the fifth switch 425 to connect the ground to one end of the third light receiving element 103.

According to an embodiment, the electronic device 301 may control the third switch 423 to connect the other end of the second light receiving element 402 to the second ADC 412. According to an embodiment, the electronic device 301 may control the fourth switch 424 to connect the other end of the third light receiving element 403 to the third ADC 413. According to an embodiment, the electronic device 301 may control the sixth switch 426 to connect the other end of the fourth light receiving element 403 to the fourth ADC 414.

According to an embodiment, the first light receiving element 401 may obtain the first voltage, the second light receiving element 402 may obtain the second voltage, the third light receiving element 403 may obtain the third voltage, and the fourth light receiving element 404 may obtain the fourth voltage. According to an embodiment, the first ADC 411 may output the first value based on the input of the first voltage. According to an embodiment, the second ADC 412 may output the second value based on the input of the second voltage. According to an embodiment, the third ADC 413 may output the third value based on the input of the third voltage. According to an embodiment, the fourth ADC 414 may output the fourth value based on the input of the fourth voltage.

According to an embodiment, the electronic device 301 may obtain the second illuminance value around the electronic device 301 based on the sum of the first value, the second value, the third value, and the fourth value.

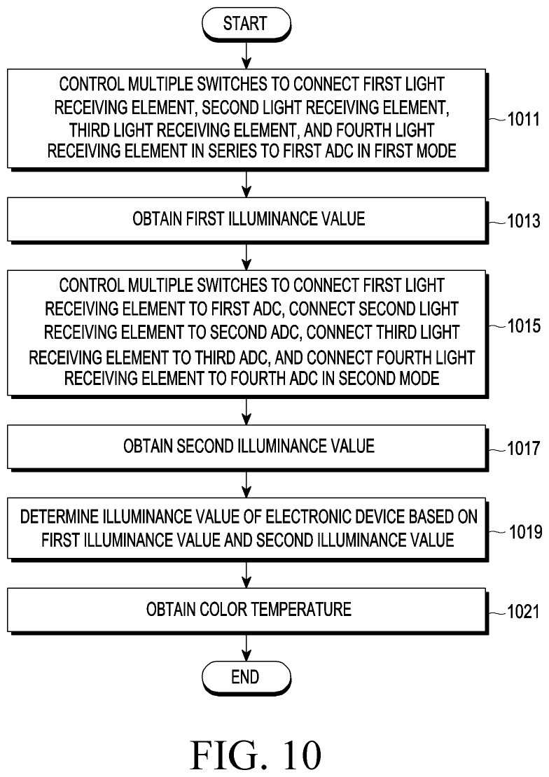

FIG. 10 is a flowchart illustrating an operation of obtaining a value related to a color temperature and an illuminance value by an electronic device according to an embodiment of the disclosure.

In the following embodiment, each operation may be sequentially performed, but is not necessarily performed sequentially. For example, the order of the operations may be changed, and at least two operations may be performed in parallel.

According to an embodiment, it may be understood that operations 1011 to 1021 are performed by a processor (e.g., the processor 320 of FIG. 3A) of an electronic device (e.g., the electronic device 301 of FIG. 3A).

Referring to FIG. 10, according to an embodiment, an illuminance sensor 340 (e.g., the illuminance sensor 340 of FIG. 3A) may be implemented in an array form. According to an embodiment, the illuminance sensor 340 may have a structure in which a plurality of second sensor arrays 342 (e.g., the second sensor array 342 of FIG. 9A) are disposed.

According to an embodiment, in operation 1011, the electronic device 301 (e.g., the electronic device 301 of FIG. 3A) may control the plurality of switches (e.g., the first switch 421 of FIG. 9A, the second switch 422 of FIG. 9A, the third switch 423 of FIG. 9A, the fourth switch 424 of FIG. 9A, the fifth switch 425 of FIG. 9A, and the sixth switch 426 of FIG. 9A) to connect the first light receiving element 401 (e.g., the first light receiving element 401 of FIG. 9A), the second light receiving element 402 (e.g., the second light receiving element 402 of FIG. 9A), the third light receiving element 403 (e.g., the third light receiving element 403 of FIG. 9A), and the fourth light receiving element 404 (e.g., the fourth light receiving element 404 of FIG. 9A) in series to the first ADC 411 (e.g., the first ADC 411 of FIG. 9A) in the first mode (e.g., short mode). According to an embodiment, the electronic device 301 may include at least one light receiving element in addition to the third light receiving element 403 and the fourth light receiving element 404. The at least one light receiving element may include at least one light receiving element capable of filtering light in a wavelength band corresponding to red R, at least one light receiving element capable of filtering light in a wavelength band corresponding to green G, or at least one light receiving element capable of filtering light in a wavelength band corresponding to blue B.

According to an embodiment, in operation 1013, the electronic device 301 may obtain the first illuminance value in the first mode. According to an embodiment, the electronic device 301 may obtain (or identify) the first illuminance value of the electronic device 301 using light sensed by the illuminance sensor 340 in a time interval in which the time when the display 360 (e.g., the display 360 of FIG. 3A) is turned off and the time when the illuminance sensor 340 is activated substantially match each other. According to an embodiment, the electronic device 301 may obtain the first illuminance value based on the voltage obtained by the first light receiving element 401, the voltage obtained by the second light receiving element 402, the voltage obtained by the third light receiving element 403, and the voltage obtained by the fourth light receiving element 404 being input to the first ADC 411.

According to an embodiment, in operation 1015, the electronic device 301 may control the first switch 421, the second switch 422, the third switch 423, and the fourth switch 424 to connect the first light receiving element 401 to the first ADC 411, connect the second light receiving element 402 to the second ADC 412, connect the third light receiving element 403 to the third ADC 413, and connect the fourth light receiving element 404 to the fourth ADC 414 in the second mode.

According to an embodiment, in operation 1017, the electronic device 301 may obtain and identify the second illuminance value in the second mode. According to an embodiment, the electronic device 301 may obtain the second illuminance value based on the voltage obtained by the first light receiving element 401 being input to the first ADC 411, the voltage obtained by the second light receiving element 402 being input to the second ADC 412, the third voltage obtained by the third light receiving element 403, and the fourth voltage obtained by the fourth light receiving element 404 being input to the fourth ADC 414.

According to an embodiment, in operation 1019, the electronic device 301 may determine the illuminance value around the electronic device 301 based on the first illuminance value and the second illuminance value. According to an embodiment, the electronic device 301 may compare the first illuminance value and the second illuminance value. According to an embodiment, the electronic device 301 may determine the illuminance value having a larger magnitude of the first illuminance value and the second illuminance value as an illuminance value around the electronic device 301 based on the comparison. According to an embodiment, the electronic device 301 may determine an average value of the first illuminance value and the second illuminance value as the illuminance value of the electronic device 301. According to an embodiment, the electronic device 301 may determine the illuminance value having a smaller magnitude of the first illuminance value and the second illuminance value as the illuminance value of the electronic device 301. This is an example, and embodiments of the disclosure may determine the illuminance value around the electronic device 301 in various ways.

According to an embodiment, in operation 1021, the electronic device 301 may obtain a value related to the color temperature based on the determined illuminance value. According to an embodiment, the electronic device 301 may obtain a value related to a color temperature based on digital values obtained in the second mode. In the second mode, the electronic device 301 may obtain the value related to the color temperature, based on the first value output based on the voltage obtained by the first light receiving element 401 being input to the first ADC 411, the second value output based on the voltage obtained by the second light receiving element 402 being input to the second ADC 412, the third value output based on the voltage obtained by the third light receiving element 403 being input to the third ADC 413, and the fourth value output based on the voltage obtained by the fourth light receiving element 404 being input to the fourth ADC 414.

According to an embodiment, after operations 1015, 1017, 1019, and 1021 are performed, operations 1011 and 1013 may be performed.

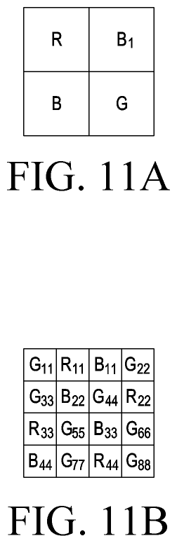

FIGS. 11A and 11B are views illustrating a plurality of light receiving elements included in a sensor array according to a comparative embodiment and a plurality of light receiving elements included in a second sensor array according to an embodiment of the disclosure.

Referring to FIG. 11A, an illuminance sensor 340 (e.g., the illuminance sensor 340 of FIG. 3A) may be disposed on a lower end of the display 360 (e.g., the display 360 of FIG. 3A). According to an embodiment, since the illuminance sensor 340 is covered by the display 360, the amount of light incident on the illuminance sensor 340 may be reduced. The illuminance sensor 340 may be implemented in an array form. The illuminance sensor 340 may be implemented as first sensor arrays 341 or second sensor arrays 342. However, for convenience of description, hereinafter, it is described that the illuminance sensor 340 is implemented as the second sensor arrays 342. The illuminance sensor 340 may include a plurality of light receiving elements including filters capable of filtering light of red R, green G, and blue B and B1 from external light.

In the first mode (e.g., short mode), the illuminance sensor 340 may be activated every designated time during the first time period. The illuminance sensor 340 may remain active for a second time period in the second mode. In this case, the time when the illuminance sensor 340 is activated may be shorter than the second time period. For example, the activation time may be about 400 μs, and the second time period may be about 25 ms. For example, the sensitivity of the illuminance sensor 340 in the first mode may be about 60 times lower than the sensitivity in the second mode (e.g., long mode).

Conventional electronic devices have a problem of obtaining relatively inaccurate illuminance values when low-illuminance light is incident due to the low sensitivity of the illuminance sensor in the first mode.

Referring to FIG. 11A, the electronic device 301 (e.g., the electronic device 301 of FIG. 3A) according to an embodiment may allow the first light receiving element 401, the second light receiving element 402, the third light receiving element 403, and the fourth light receiving element 404 included in the second sensor array 342 to be connected in series to the first ADC 411 to solve the problem with the conventional electronic device. The first light receiving element 401 may include a filter for filtering red R light, the second light receiving element 402 may include a filter for filtering green G light, the third light receiving element 403 may include a filter for filtering blue B light, and the fourth light receiving element 404 may include a filter for filtering blue B1 light. As the total voltage of voltages obtained by the first light receiving element 401, the second light receiving element 402, the third light receiving element 403, and the fourth light receiving element 404 is input to the first ADC 411, the electronic device 301 may obtain a digital value. The electronic device 301 according to an embodiment may obtain a first illuminance value based on the digital value. However, the number and arrangement of the plurality of light receiving elements shown in FIG. 11A are an example, and there is no limitation to the number and arrangement of the plurality of light receiving elements.

Referring to part of FIG. 11B, the electronic device according to the comparative embodiment may obtain an illuminance value using more light receiving elements than the number of the plurality of light receiving elements included in the second sensor array 342 to solve the problems with the conventional electronic device. Since the sensor array of the electronic device according to the comparative embodiment includes more light receiving elements than the number of the plurality of light receiving elements included in the second sensor array 342, it is relatively larger in size than the second sensor array 342. Each of the plurality of light receiving elements according to the comparative embodiment may be connected to a respective one of the ADCs corresponding to the plurality of light receiving elements R11, R22, R33, R44, G11, G22, G33, G44, G55, G66, G77, G88, B11, B22, B33, and B44. The electronic device according to the comparative embodiment may include a plurality of light receiving elements R11, R22, R33, and R44 including a filter for filtering red light, a plurality of light receiving elements G11, G22, G33, G44, G55, G66, G77, and G88 including a filter for filtering blue light, and a plurality of light receiving elements B11, B22, B33, and B44 including a filter for filtering blue light. The sensor array according to the comparative embodiment may obtain a first illuminance value based on the sum of digital values output by the respective ADCs. However, the number and arrangement of the plurality of light receiving elements shown in FIG. 11B are an example, and there is no limitation to the number and arrangement of the plurality of light receiving elements.

The size of the second sensor array according to an embodiment may be smaller than the size of the sensor array according to the comparative embodiment.

According to the above-described methods, the electronic device 301 may increase the sensitivity of the illuminance sensor 340 to external light even without increasing the size of the illuminance sensor 340. Further, the electronic device 301 may enhance the color temperature division power (or color temperature resolution) of the illuminance sensor 340 for external light even without increasing the size of the illuminance sensor 340. Accordingly, the electronic device 301 may more effectively provide the EAD function of the display 360.

An electronic device 301 according to an embodiment may comprise a display 360, a sensor including disposed on a lower end portion of the display 360 and including a plurality of light receiving elements 400, 401, 402, 403, 404, a plurality of analog-to-digital converters (ADCs) 410, 411, 412, 413, 414 and a plurality of switches 421, 422, 423, 424, 425, 426, at least one processor 320, and memory 130.

According to an embodiment, the plurality of light receiving elements may include a first light receiving element 401, a second light receiving element 402, and a third light receiving element 403 configured to detect light of different wavelengths.

According to an embodiment, the plurality of ADCs may include a first ADC 411 corresponding to the first light receiving element 401, a second ADC 412 corresponding to the second light receiving element 402, and a third ADC 413 corresponding to the third light receiving element 403.

The memory 130 according to an embodiment may store instructions that, when executed by the at least one processor 320, cause the electronic device to control the plurality of switches to connect the first light receiving element 401, the second light receiving element 402, and the third light receiving element 403 in series to the first ADC 411 in a first mode in which the plurality of light receiving elements are activated every designated time during a first time period.

The memory 130 according to an embodiment may store instructions that, when executed by the at least one processor 320, cause the electronic device to control the plurality of switches to connect the first light receiving element 401 to the first ADC 411, connect the second light receiving element 402 to the second ADC, and connect the third light receiving element 403 to the third ADC 413 in a second mode in which the plurality of light receiving elements remain active during a second time period.

The plurality of switches according to an embodiment may include a first switch 421 disposed between a ground and one end of the first light receiving element 401.

Another end of the first light receiving element 401 according to an embodiment may be connected to the first ADC 411.

The plurality of switches according to an embodiment may include a second switch 422 disposed between the ground and one end of the second light receiving element 402.

The plurality of switches according to an embodiment may include a third switch 423 connecting the one end of the first light receiving element 401 to another end of the second light receiving element 402 or connecting the other end of the second light receiving element 402 to the second ADC 412.

The plurality of switches according to an embodiment may include a fourth switch 424 connecting the one end of the second light receiving element 402 to another end of the third light receiving element 403 or connecting the other end of the third light receiving element 403 to the third ADC 413.

One end of the third light receiving element 403 according to an embodiment may be connected to the ground.

The memory 130 according to an embodiment may store instructions that, when executed by the at least one processor 320, cause the electronic device to, in the first mode, open the first switch 421 not to connect the ground to the one end of the first light receiving element 401.

The memory 130 according to an embodiment may store instructions that, when executed by the at least one processor 320, cause the electronic device to, in the first mode, open the second switch 422 not to connect the ground to the one end of the second light receiving element 402.

The memory 130 according to an embodiment may store instructions that, when executed by the at least one processor 320, cause the electronic device to, in the first mode, control the third switch 423 to connect the one end of the first light receiving element 401 to the other end of the second light receiving element 402.

The memory 130 according to an embodiment may store instructions that, when executed by the at least one processor 320, cause the electronic device to, in the first mode, control the fourth switch 424 to connect the one end of the second light receiving element 402 to the other end of the third light receiving element 403.

The memory 130 according to an embodiment may store instructions that, when executed by the at least one processor 320, cause the electronic device to, in the second mode, short the first switch 421 to connect the ground to the one end of the first light receiving element 401.

The memory 130 according to an embodiment may store instructions that, when executed by the at least one processor 320, cause the electronic device to, in the second mode, short the second switch 421 to connect the ground to the one end of the second light receiving element 402.

The memory 130 according to an embodiment may store instructions that, when executed by the at least one processor 320, cause the electronic device to, in the second mode, control the third switch to connect the other end of the second light receiving element 402 to the second ADC 412.

The memory 130 according to an embodiment may store instructions that, when executed by the at least one processor 320, cause the electronic device to, in the second mode, control the fourth switch 424 to connect the other end of the third light receiving element 403 to the third ADC 413.

The memory 130 according to an embodiment may store instructions that, when executed by the at least one processor 320, cause the electronic device to in the first mode, obtain, a first illuminance value based on a fourth voltage, which is a sum of a first voltage obtained by the first light receiving element 401, a second voltage obtained by the second light receiving element 402, and a third voltage obtained by the third light receiving element 403, being input to the first ADC 411.

The memory 130 according to an embodiment may store instructions that, when executed by the at least one processor 320, cause the electronic device to, in the second mode, obtain a second illuminance value using a first value obtained by inputting a first voltage obtained by the first light receiving element 401 to the first ADC 411, a second value obtained by inputting a second voltage obtained by the second light receiving element 402 to the second ADC 412, and a third value obtained by inputting a third voltage obtained by the third light receiving element 403 to the third ADC 413.

The memory 130 according to an embodiment may store instructions that, when executed by the at least one processor 320, cause the electronic device to obtain a value related to a color temperature based on the first value, the second value, and the third value.

The memory 130 according to an embodiment may store instructions that, when executed by the at least one processor 320, cause the electronic device to determine an illuminance value of the electronic device 301 based on the first illuminance value obtained in the first mode and the second illuminance value obtained in the second mode.

The memory 130 according to an embodiment may store instructions that, when executed by the at least one processor 320, cause the electronic device to compare a magnitude of the first illuminance value and a magnitude of the second illuminance value.

The memory 130 according to an embodiment may store instructions that, when executed by the at least one processor 320, cause the electronic device to determine an illuminance value having a larger magnitude of the first illuminance value and the second illuminance value as an illuminance value of the electronic device 301.

The plurality of light receiving elements according to an embodiment may be implemented in an array form.

A method for operating an electronic device 301 according to an embodiment may comprise controlling the plurality of switches to connect the first light receiving element 401, the second light receiving element 402, and the third light receiving element 403 in series to the first ADC 411 in a first mode in which the plurality of light receiving elements are activated every designated time during a first time period.

The method for operating the electronic device 301 according to an embodiment may comprise controlling the plurality of switches to connect the first light receiving element 401 to the first ADC 411, connect the second light receiving element 402 to the second ADC 412, and connect the third light receiving element 403 to the third ADC 413 in a second mode in which the plurality of light receiving elements remain active during a second time period.

The method for operating the electronic device 301 according to an embodiment may comprise opening the first switch 421 not to connect the ground to the one end of the first light receiving element 401.

The method for operating the electronic device 301 according to an embodiment may comprise opening the second switch 421 not to connect the ground to the one end of the second light receiving element 402.

The method for operating the electronic device 301 according to an embodiment may comprise controlling the third switch 423 to connect the one end of the first light receiving element 401 to the other end of the second light receiving element 402.

The method for operating the electronic device 301 according to an embodiment may comprise controlling the fourth switch 424 to connect the one end of the second light receiving element 402 to the other end of the third light receiving element 403.

The method for operating the electronic device 301 according to an embodiment may comprise shorting the first switch 421 to connect the ground to the one end of the first light receiving element 401.

The method for operating the electronic device 301 according to an embodiment may comprise shorting the second switch 422 to connect the ground to the one end of the second light receiving element 402.

The method for operating the electronic device 301 according to an embodiment may comprise controlling the third switch 423 to connect the other end of the second light receiving element 402 to the second ADC 412.

The method for operating the electronic device 301 according to an embodiment may comprise controlling the fourth switch 424 to connect the other end of the third light receiving element 403 to the third ADC 413.

The method for operating the electronic device 301 according to an embodiment may comprise, in the first mode, obtaining, a first illuminance value based on a fourth voltage, which is a sum of a first voltage obtained by the first light receiving element 401, a second voltage obtained by the second light receiving element 402, and a third voltage obtained by the third light receiving element 403, being input to the first ADC 411.

The method for operating the electronic device 301 according to an embodiment may comprise, in the second mode, obtaining a second illuminance value using a first value obtained by inputting a first voltage obtained by the first light receiving element 401 to the first ADC 411, a second value obtained by inputting a second voltage obtained by the second light receiving element 402 to the second ADC 412, and a third value obtained by inputting a third voltage obtained by the third light receiving element to the third ADC 413.

The method for operating the electronic device 301 according to an embodiment may comprise obtaining a value related to a color temperature based on the first value, the second value, and the third value.

The method for operating the electronic device 301 according to an embodiment may comprise determining an illuminance value of the electronic device based on the first illuminance value obtained in the first mode and the second illuminance value obtained in the second mode.

The method for operating the electronic device 301 according to an embodiment may comprise comparing a magnitude of the first illuminance value and a magnitude of the second illuminance value.

The method for operating the electronic device 301 according to an embodiment may comprise determining an illuminance value having a larger magnitude of the first illuminance value and the second illuminance value as an illuminance value of the electronic device 301.

A non-transitory recording medium according to an embodiment may store at least one instruction capable of executing controlling a plurality of switches to connect a first light receiving element 401, a second light receiving element 401, and a third light receiving element 403 in series to a first ADC 411 in a first mode in which the plurality of light receiving elements are activated every designated time during a first time period.

The non-transitory recording medium according to an embodiment may store at least one instruction capable of executing controlling the plurality of switches to connect the first light receiving element 401 to the first ADC 411, connect the second light receiving element 402 to the second ADC 412, and connect the third light receiving element 403 to the third ADC 413 in a second mode in which the plurality of light receiving elements remain active during a second time period.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101 or the electronic device 301). For example, a processor (e.g., the processor 120 or processor 320) of the machine (e.g., the electronic device 101 or electronic device 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a display;
a sensor, disposed on a lower end portion of the display, including a plurality of light receiving elements, a plurality of analog-to-digital converters (ADCs), and a plurality of switches,
wherein the plurality of light receiving elements include:
a first light receiving element,
a second light receiving element, and
a third light receiving element configured to detect light of different wavelengths, and
wherein the plurality of ADCs include a first ADC corresponding to the first light receiving element, a second ADC corresponding to the second light receiving element, and a third ADC corresponding to the third light receiving element;
memory, comprising one or more storage media, storing instructions; and
one or more processors communicatively coupled to the display, the sensor, and the memory,
wherein the instructions, when executed by the one or more processors individually or collectively, cause the electronic device to:
control the plurality of switches to connect the first light receiving element, the second light receiving element, and the third light receiving element in series to the first ADC in a first mode in which the plurality of light receiving elements are activated every designated time during a first time period, and
control the plurality of switches to connect the first light receiving element to the first ADC, connect the second light receiving element to the second ADC, and connect the third light receiving element to the third ADC in a second mode in which the plurality of light receiving elements remain active during a second time period.

2. The electronic device of claim 1,
wherein the plurality of switches include:
a first switch disposed between a ground and one end of the first light receiving element, another end of the first light receiving element being connected to the first ADC,
a second switch disposed between the ground and one end of the second light receiving element,
a third switch connecting the one end of the first light receiving element to another end of the second light receiving element or connecting the other end of the second light receiving element to the second ADC, and
a fourth switch connecting the one end of the second light receiving element to another end of the third light receiving element or connecting the other end of the third light receiving element to the third ADC, and
wherein one end of the third light receiving element is connected to the ground.

3. The electronic device of claim 2, wherein the instructions, when executed by the one or more processors individually or collectively, further cause the electronic device to, in the first mode:
open the first switch not to connect the ground to the one end of the first light receiving element;
open the second switch not to connect the ground to the one end of the second light receiving element;
control the third switch to connect the one end of the first light receiving element to the other end of the second light receiving element; and
control the fourth switch to connect the one end of the second light receiving element to the other end of the third light receiving element.

4. The electronic device of claim 3, wherein the instructions, when executed by the one or more processors individually or collectively, further cause the electronic device to, in the second mode, short the first switch to connect the ground to the one end of the first light receiving element, short the second switch to connect the ground to the one end of the second light receiving element, control the third switch to connect the other end of the second light receiving element to the second ADC, and control the fourth switch to connect the other end of the third light receiving element to the third ADC.

5. The electronic device of claim 1, wherein the instructions, when executed by the one or more processors individually or collectively, further cause the electronic device to, in the first mode, obtain a first illuminance value based on a fourth voltage, which is a sum of a first voltage obtained by the first light receiving element, a second voltage obtained by the second light receiving element, and a third voltage obtained by the third light receiving element, being input to the first ADC.

6. The electronic device of claim 1, wherein the instructions, when executed by the one or more processors individually or collectively, further cause the electronic device to, in the second mode, obtain a second illuminance value using a first value obtained by inputting a first voltage obtained by the first light receiving element to the first ADC, a second value obtained by inputting a second voltage obtained by the second light receiving element to the second ADC, and a third value obtained by inputting a third voltage obtained by the third light receiving element to the third ADC.

7. The electronic device of claim 6, wherein the instructions, when executed by the one or more processors individually or collectively, further cause the electronic device to obtain a value related to a color temperature based on the first value, the second value, and the third value.

8. The electronic device of claim 6, wherein the instructions, when executed by the one or more processors individually or collectively, further cause the electronic device to determine an illuminance value of the electronic device based on the first illuminance value obtained in the first mode and the second illuminance value obtained in the second mode.

9. The electronic device of claim 8, wherein the instructions, when executed by the one or more processors individually or collectively, further cause the electronic device to:
compare a magnitude of the first illuminance value and a magnitude of the second illuminance value; and
based on the comparison, determine an illuminance value having a larger magnitude of the first illuminance value and the second illuminance value as an illuminance value of the electronic device.

10. The electronic device of claim 1, wherein the plurality of light receiving elements are implemented in an array form.

11. A method for operating an electronic device, the method comprising:
controlling a plurality of switches to connect a first light receiving element, a second light receiving element, and a third light receiving element in series to a first analog to digital converter (ADC) in a first mode in which the plurality of light receiving elements are activated every designated time during a first time period; and
controlling the plurality of switches to connect the first light receiving element to the first ADC, connect the second light receiving element to a second ADC, and connect the third light receiving element to a third ADC in a second mode in which the light receiving elements remain active during a second time period.

12. The method of claim 11,
wherein the plurality of switches include:
a first switch disposed between a ground and one end of the first light receiving element, another end of the first light receiving element being connected to the first ADC;
a second switch disposed between the ground and one end of the second light receiving element;
a third switch connecting the one end of the first light receiving element to another end of the second light receiving element or connecting the other end of the second light receiving element to the second ADC; and
a fourth switch connecting the one end of the second light receiving element to another end of the third light receiving element or connecting the other end of the third light receiving element to the third ADC, and
wherein one end of the third light receiving element is connected to the ground.

13. The method of claim 12, wherein controlling the plurality of switches to connect the first light receiving element, the second light receiving element, and the third light receiving element in series to the first ADC comprises:
opening the first switch not to connect the ground to the one end of the first light receiving element,
opening the second switch not to connect the ground to the one end of the second light receiving element,
controlling the third switch to connect the one end of the first light receiving element to the other end of the second light receiving element, and
controlling the fourth switch to connect the one end of the second light receiving element to the other end of the third light receiving element.

14. The method of claim 13, wherein controlling the plurality of switches comprises:
connecting the first light receiving element to the first ADC;
connecting the second light receiving element to the second ADC; and
connecting the third light receiving element to the third ADC by shorting the first switch to connect the ground to the one end of the first light receiving element, shorting the second switch to connect the ground to the one end of the second light receiving element, controlling the third switch to connect the other end of the second light receiving element to the second ADC, and controlling the fourth switch to connect the other end of the third light receiving element to the third ADC.

15. The method of claim 14, further comprising, in the first mode, obtaining a first illuminance value based on a fourth voltage, which is a sum of a first voltage obtained by the first light receiving element, a second voltage obtained by the second light receiving element, and a third voltage obtained by the third light receiving element, being input to the first ADC.

16. The method of claim 15, further comprising, in the second mode, obtaining a second illuminance value using a first value obtained by inputting a first voltage obtained by the first light receiving element to the first ADC, a second value obtained by inputting a second voltage obtained by the second light receiving element to the second ADC, and a third value obtained by inputting a third voltage obtained by the third light receiving element to the third ADC.

17. The method of claim 16, further comprising obtaining a value related to a color temperature based on the first value, the second value, and the third value.

18. The method of claim 16, further comprising determining an illuminance value of the electronic device based on the first illuminance value obtained in the first mode and the second illuminance value obtained in the second mode.

19. One or more non-transitory computer-readable storage media storing one or more computer programs including computer-executable instructions, that, when executed by one or more processors of an electronic device individually or collectively, cause the electronic device to perform operations, the operations comprising:
controlling a plurality of switches to connect a first light receiving element, a second light receiving element, and a third light receiving element in series to a first analog to digital converter (ADC) in a first mode in which the light receiving elements are activated every designated time during a first time period; and
controlling the plurality of switches to connect the first light receiving element to the first ADC, connect the second light receiving element to a second ADC, and connect the third light receiving element to a third ADC in a second mode in which the plurality of light receiving elements remain active during a second time period.

20. The one or more non-transitory computer-readable storage media of claim 19, the operations further comprising, in the first mode, obtaining a first illuminance value based on a fourth voltage, which is a sum of a first voltage obtained by the first light receiving element, a second voltage obtained by the second light receiving element, and a third voltage obtained by the third light receiving element, being input to the first ADC.
